(19) United States
(12) Patent Application Publication
(10) Pub. No.: US 2026/0214306 A1
(43) Pub. Date: Jul. 23, 2026

(54) SERVER, METHOD AND COMPUTER PROGRAM

(71) Applicant: 17LIVE Japan Inc., Tokyo (JP)

(72) Inventors: Yu-Chuan CHANG, Taipei City (TW); Yung-Chi HSU, Taipei City (TW); Yu-Chun CHEN, Taipei City (TW); Wei-Kun LU, Taipei City (TW); Bao-Min CHANG, Taipei City (TW); Guan-Hong LIU, Taipei City (TW); Yu-Wen HUANG, Taipei City (TW)

(21) Appl. No.: 19/454,227

(22) Filed: Jan. 20, 2026

(30) Foreign Application Priority Data
Jan. 22, 2025 (JP) 2025-009306
Mar. 27, 2025 (JP) 2025-053884
Jun. 18, 2025 (JP) 2025-102767

(51) Int. Cl. H04N 21/854; H04N 21/2187; H04N 21/234; H04N 21/266

(52) U.S. Cl. CPC H04N 21/854; H04N 21/2187; H04N 21/23418; H04N 21/266

(57) ABSTRACT

A server comprising a circuitry, wherein the circuitry is configured to perform: detecting a first triggering point in the live streaming room; extracting a first portion of a streamer from a streaming data provided by the streamer in response to the first triggering point in the live streaming room being detected; performing processing of image editing with respect to the first portion; and rendering the edited first portion on the streaming data. According to the present disclosure, it may motivate the viewers to have more interaction with the livestreamer. Moreover, it may add more fun to the live streaming room, and also make the interaction in the live streaming room smoother. Therefore, the user experience may be improved.

### CROSS-REFERENCE TO RELATED APPLICATIONS

This application is based on and claims the benefit of priority from Japanese Patent Application Serial No. 2025-009306 (filed on Jan 22, 2025), No. 2025-053884 (filed on Mar. 27, 2025), and No. 2025-102767 (filed on Jun. 18, 2025), the contents of which are hereby incorporated by reference in their entirety.

### BACKGROUND OF THE DISCLOSURE

### Technical Field

This disclosure relates to information and communication technology, and in particular, to a server, method and computer program in a live streaming.

### Description of the Related Art

Some APPs or platforms provide live streaming service for livestreamers and viewers to interact with each other. The livestreamers may have a performance to cheer up the viewer and the viewer may send gifts to support the livestreamers.

The interaction between the viewers and livestreamers plays an important role in the live streaming room. Patent Document 1 disclosed a method to improve the interaction of the livestreamer and viewers in the live streaming room.

However, the current technology seems not enough to satisfy the needs of the viewers and the livestreamers. This may lead to poor user experience. Therefore, how to improve the user experience is very important.

The interaction between the viewers and livestreamers plays an important role in the live streaming room. Patent Document 2 disclosed a method to improve the interaction of the livestreamer and viewers in the live streaming room.

However, the current technology seems not enough to satisfy the needs of the viewers and the livestreamers. This may lead to poor user experience. Therefore, how to improve the user experience is very important.

Sometimes if the viewers do not cheer up the livestreamer, the livestreamer may feel depressed and the interaction between viewers and livestreamer may get worse and worse. Patent Document 3 disclosed a method to introduce an AI chatbot with a character to motivate the interaction and fun in the live streaming room.

However, the viewers and the livestreamers may feel bored or even annoyed if the AI chatbot keeps doing the same thing as them or the like. This may lead to poor user experience. Therefore, an enhanced method or alternative to improve the user experience is on demand.

### SUMMARY OF THE INVENTION

An embodiment of subject application relates to a server including a circuitry, wherein the circuitry is configured to perform: detecting a first triggering point in the live streaming room; extracting a first portion of a streamer from a streaming data provided by the streamer in response to the first triggering point in the live streaming room being detected; performing processing of image editing with respect to the first portion; and rendering the edited first portion on the streaming data.

Another embodiment of subject application relates to a method, including: detecting a first triggering point in the live streaming room; extracting a first portion of a streamer from a streaming data provided by the streamer in response to the first triggering point in the live streaming room being detected; performing processing of image editing with respect to the first portion; and rendering the edited first portion on the streaming data.

Another embodiment of subject application relates to a computer program for causing a server to realize the functions of: detecting a first triggering point in the live streaming room; extracting a first portion of a streamer from a streaming data provided by the streamer in response to the first triggering point in the live streaming room being detected; performing processing of image editing with respect to the first portion; and rendering the edited first portion on the streaming data.

According to the present disclosure, it may motivate the viewers to have more interaction with the livestreamer. Moreover, it may add more fun to the live streaming room, and also make the interaction in the live streaming room smoother. Therefore, the user experience may be improved.

An embodiment of subject application relates to a server including a circuitry, wherein the circuitry is configured to perform: receiving a request from a first user of a first user terminal to use a virtual gift item associated with a first point; generating a second point based on the first point, wherein the generated second point is higher than, equal to, or lower than the first point; displaying the generated second point to a second user of a second user terminal in a live streaming room; and updating points of the first user and the second user based on the first point and generated second point; wherein a mission associated with the live streaming room is triggered in response to the generated second point being lower than a threshold point.

Another embodiment of subject application relates to a method, including: receiving a request from a first user of a first user terminal to use a virtual gift item associated with a first point; generating a second point based on the first point, wherein the generated second point is higher than, equal to, or lower than the first point; displaying the generated second point to a second user of a second user terminal in a live streaming room; and updating points of the first user and the second user based on the first point and generated second point; wherein a mission associated with the live streaming room is triggered in response to the generated second point being lower than a threshold point.

Another embodiment of subject application relates to a computer program for causing a server to realize the functions of: receiving a request from a first user of a first user terminal to use a virtual gift item associated with a first point; generating a second point based on the first point, wherein the generated second point is higher than, equal to, or lower than the first point; displaying the generated second point to a second user of a second user terminal in a live streaming room; and updating points of the first user and the second user based on the first point and generated second point; wherein a mission associated with the live streaming room is triggered in response to the generated second point being lower than a threshold point.

According to the present disclosure, it may motivate the viewers to have more interaction with the livestreamer. Moreover, it may add more fun to the live streaming room, and also make the interaction in the live streaming room smoother. Therefore, the user experience may be improved.

An embodiment of subject application relates to a method, including: retrieving event data associated with an event in which a first user of a first user terminal is participating in; determining an emotional state and/or an appearance transformation corresponding to a progress state of the event; generating a prompt command based on the emotional state and/or the appearance transformation; transmitting the prompt command to an AI carrier associated with the first user of the first user terminal; and updating the emotional state and/or the appearance transformation on the AI carrier according to the prompt command.

Another embodiment of subject application relates to a server including a circuitry, wherein the circuitry is configured to perform: retrieving event data associated with an event in which a first user of a first user terminal is participating in; determining an emotional state and/or an appearance transformation corresponding to a progress state of the event; generating a prompt command based on the emotional state and/or the appearance transformation; transmitting the prompt command to an AI carrier associated with the first user of the first user terminal; and updating the emotional state and/or the appearance transformation on the AI carrier according to the prompt command.

Another embodiment of subject application relates to a computer program for causing a server to realize the functions of: retrieving event data associated with an event in which a first user of a first user terminal is participating in; determining an emotional state and/or an appearance transformation corresponding to a progress state of the event; generating a prompt command based on the emotional state and/or the appearance transformation; transmitting the prompt command to an AI carrier associated with the first user of the first user terminal; and updating the emotional state and/or the appearance transformation on the AI carrier according to the prompt command.

According to the present disclosure, it may improve the usage of the AI model in the live streaming room. Moreover, another way to enhance the interaction and motivate viewers to support the streamers is also provided. Therefore, the livestreamers and viewers may feel interested and satisfied, instead of feeling anxious, and the user experience may be enhanced. Therefore, the user experience may be improved.

### BRIEF DESCRIPTION OF THE DRAWINGS

FIG. 1 is a schematic configuration of a live streaming system 1 according to some embodiments of subject application;

FIG. 2 is a schematic block diagram of the user terminal 20 according to some embodiments of subject application;

FIG. 3 is a schematic block diagram of the server 10 according to some embodiments of subject application;

FIG. 4 shows an exemplary data structure of the stream DB 320 of FIG. 3;

FIG. 5 shows an exemplary data structure of the user DB 322 of FIG. 3;

FIG. 6 shows an exemplary data structure of the gift DB 324 of FIG. 3;

FIG. 7 shows an exemplary data structure of the event DB 326 of FIG. 3;

FIG. 8 shows an exemplary data structure of the context DB 328 of FIG. 3;

FIG. 9 is exemplary functional configuration of the live streaming system 1 according to some embodiments of subject application;

FIG. 10 - FIG. 17 are exemplary screen images of a live-streaming room screen 600 shown on the display of the livestreamer user terminal 20 or the viewer user terminal 30;

FIG. 18 is a schematic block diagram of the user terminal 120 according to some embodiments of subject application;

FIG. 19 is a schematic block diagram of the Server 110 according to some embodiments of subject application;

FIG. 20 shows an exemplary data structure of the gift DB 324 of FIG. 19;

FIG. 21 shows an exemplary data structure of the mission DB 1326 of FIG. 19;

FIG. 22 shows an exemplary data structure of the script DB 1328 of FIG. 19;

FIG. 23 - FIG. 24 are exemplary functional configurations of the live streaming system 1 according to some embodiments of subject application;

FIG. 25 - FIG. 30 are exemplary screen images of a live streaming room screen 600 shown on the display of the livestreamer user terminal 120 or the viewer user terminal 130;

FIG. 31 is flowchart showing steps of the triggering of the mission in the live streaming room as an embodiment;

FIG. 32 is flowchart showing steps of the mission in the live streaming room as an embodiment;

FIG. 33 is a schematic block diagram of the user terminal 220 according to some embodiments of subject application;

FIG. 34 is a schematic block diagram of the Server 210 according to some embodiments of subject application;

FIG. 35 shows an exemplary data structure of the gift DB 324 of FIG. 34;

FIG. 36 shows an exemplary data structure of the event DB 2326 of FIG. 34;

FIG. 37 shows an exemplary data structure of the AI carrier DB 2328 of FIG. 34;

FIG. 38 is exemplary functional configuration of the live streaming system 1 according to some embodiments of subject application;

FIG. 39 - FIG. 43 are exemplary screen images of a live-streaming room screen 600 shown on the display of the livestreamer user terminal 220 or the viewer user terminal 230;

FIG. 44 is an exemplary hardware configuration of the information processing device according to some embodiments of subject application.

### DETAILED DESCRIPTION

Hereinafter, the identical or similar components, members, procedures or signals shown in each drawing are referred to with like numerals in all the drawings, and thereby an overlapping description is appropriately omitted. Additionally, a portion of a member which is not important in the explanation of each drawing is omitted.

The live streaming system 1 according to some embodiments of subject application provides enhancement among the users to communicate and interact smoothly. More specifically, it entertains the viewers and livestreamers in a technical way.

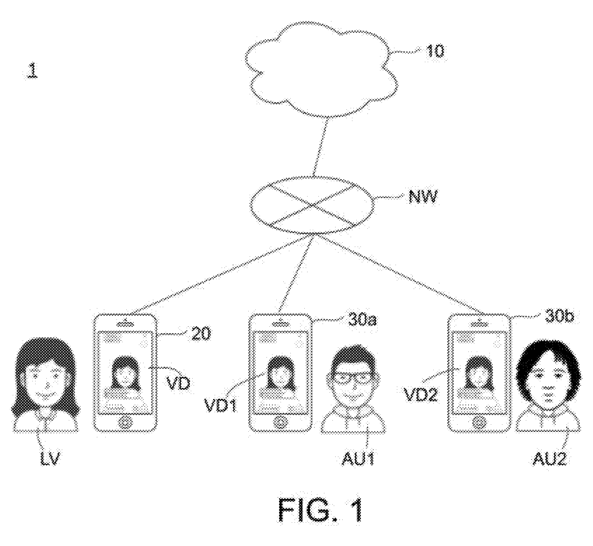

FIG. 1 shows a schematic configuration of a live streaming system 1 according to some embodiments of subject application. The live streaming system 1 provides a live streaming service for the streaming livestreamer (may also be referred as liver, streamer or distributor) LV and viewer (may also be referred as audience) AU (AU1, AU2...) to interact mutually in real time. As shown in FIG. 1, the live streaming system 1 may include a server 10, a user terminal 20(20, 120, 220) and a user terminal 30(130, 230, 30a, 30b, 130a, 130b, 230a, 230b...). The user terminal 20 may be a livestreamer and the user terminal 30 may be a viewer. In some embodiments, the livestreamers and viewers may be referred to as the user. The server 10 may include one or a plurality of information processing devices connected via network NW. The user terminal 20 and 30 may be, for example, a portable terminal such as the smartphone, tablet, laptop PC, recorder, mobile game console, wearable device or the like, or the stationary computer such as desktop PC. The server 10, user terminal 20 and user terminal 30 may be communicably connected by any type of wire or wireless network NW.

The live streaming system 1 is involved in the livestreamer LV, the viewer AU, and APP provider (not shown), who provides the server 10. The livestreamer LV may record his/her own contents such as songs, talks, performance, game streaming or the like by his/her own user terminal 20 and upload to the server 10 and be the one who distributes contents in real time. In some embodiments, the livestreamer LV may interact with the viewer AU via the live streaming.

The APP provider may provide a platform for the contents to go on live streaming in the server 10. In some embodiments, the APP provider may be the media or manager to manage the real time communication between the livestreamer LV and viewer AU. The viewer AU may access the platform by the user terminal 30 to select and watch the contents he/she would like to watch. The viewer AU may perform operations to interact with the livestreamer, such as commenting or cheering the livestreamer, by the user terminal 30. The livestreamer, who provides the contents, may respond to the comment or cheer. The response of the livestreamer may be transmitted to the viewer AU by video and/or audio or the like. Therefore, a mutual communication among the livestreamer and viewer may be accomplished.

The “live streaming” in this specification may be referred to as the data transmission which enables the contents the livestreamer LV recorded by the user terminal 20 to be substantially reproduced and watched by the viewer AU via the user terminal 30, In some embodiments, the “live streaming” may also refer to the streaming which is accomplished by the above data transmission. The live streaming may be accomplished by the well-known live streaming technology such as HTTP Live Streaming, Common Media Application Format, Web Real-Time Communications, Real-Time Messaging Protocol, MPEG DASH or the like. The live streaming may further include the embodiment that the viewer AU may reproduce or watch the contents with specific delay while the livestreamer is recording the contents. Regarding the magnitude of the delay, it should be at least small enough to enable the livestreamer LV and the viewer AU to communicate. However, live streaming is different from so-called on-demand streaming. More specifically, the on-demand streaming may be referred to as storing all data, which records the contents, in the server and then providing the data from the server to the user at random timing according to the user’s request.

The “streaming data” in this specification may be referred to as the data includes image data or voice data. More specifically, the image data (may be referred to as video data) may be generated by the image pickup feature of the user terminal 20 and 30. The voice data (may be referred to as audio data) may be generated by the audio input feature of the user terminal 20 and 30. The streaming data may be reproduced by the user terminal 2030, so that the contents relating to users may be available for watching. In some embodiments, during the period from the streaming data being generated by the user terminal of the livestreamer to being reproduced by the user terminal of the viewer, the processing of changing format, size or specification of the data, such as compression, extension, encoding, decoding, transcoding or the like, is predictable. Before and after this kind of processing, the contents (such as video and audio) are substantially unchanged, so it is described in the current embodiments of the present disclosure that the streaming data before being processed is the same as that after being processed. In other words, if the streaming data is generated by the user terminal of the livestreamer and reproduced by the user terminal of the viewer via the server 10, the streaming data generated by the user terminal of the livestreamer, the streaming data passed through the server 10 and the streaming data received and reproduced by the by the user terminal of the viewer are all the same streaming data.

As shown in FIG. 1, the livestreamer LV is providing the live streaming. The user terminal 20 of the livestreamer generates the streaming data by recording his/her video and/or audio, and transmits to the server 10 via the network NW. At the same time, the user terminal 20 may display the video VD on the display of the user terminal 20 to check the streaming contents of the livestreamer LV.

The viewer AU1, AU2 of the user terminal 30a, 30b, who request the platform to provide the live streaming of the livestreamer, may receive streaming data corresponding to the live streaming via the network NW and reproduce the received streaming data to display the video VD1, VD2 on the display and output the audio from a speaker or the like. The video VD1, VD2 displayed on the user terminal 30a, 30b respectively may be substantially the same as the video VD recorded by the user terminal of the livestreamer LV, and the audio outputted from the terminal 30a, 30b may also be substantially the same as the audio recorded by the user terminal of the livestreamer LV.

The recording at the user terminal 20 of the livestreamer may be simultaneous with the reproducing of the streaming data at the user terminal 30a, 30b of the viewer AU1, AU2. If a viewer AU1 inputs a comment on the contents of the livestreamer LV into the user terminal 30a, the server 10 will display the comment on the user terminal 20 of the livestreamer in real time, and also display on the user terminal 30a, 30b of the viewer AU1, AU2 respectively. If the livestreamer LV responds to the comment, the response may be outputted as the text, image, video or audio from the terminal 30a, 30b of the viewer AU1, AU2, so that the communication of the livestreamer LV and viewer LV may be realized. Therefore, the live streaming system may realize the live streaming of two-way communication.

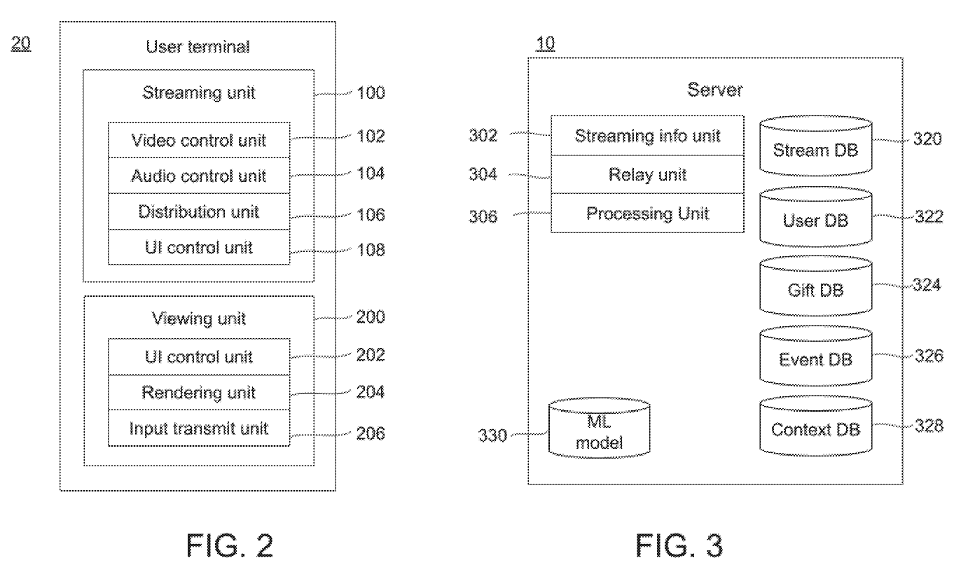

FIG. 2 is a block diagram showing a function and configuration of the user terminal 20 in FIG. 1 according to the embodiment of the present disclosure. The user terminal 30 has the similar function and configuration of the user terminal 20. The blocks depicted in the block diagram of this specification are implemented in hardware such as devices like a CPU of a computer or mechanical components, and in software such as a computer program depicts functional blocks implemented by the cooperation of these elements. Therefore, it will be understood by those skilled in the art that the functional blocks may be implemented in a variety of manners by a combination of hardware and software.

The livestreamer LV and viewer AU may download and install the live streaming application (live streaming APP) of the present disclosure to the user terminal 20 and 30 from the download site via network NW. Or the live streaming APP may be pre-installed in the user terminal 20 and 30. By the execution of the live streaming by the user terminal 20 and 30, the user terminals 20 and 30 may communicate with the server 10 via the network NW to realize a plurality of functions. The functions realized by the execution of the live streaming APP by the user terminal 20 and 30 (More specifically, the processor such as CPU) is described below as the functions of the user terminal 20 and 30. These functions are basically the functions that the live streaming APP makes the user terminals 20 and 30 realize. In some embodiments, these functions may also be realized by transmitting from the server 10 to the web browser of the user terminal 20 and 30 via network NW and be executed by the computer program of the web browser. The computer program may be written in the programming language such as HTML (Hyper Text Markup Language) or the like.

The user terminal 20 includes streaming unit 100 and viewing unit 200. In some embodiments, the streaming unit 100 is configured to record the audio and/or video data of the user and generate streaming data to transmit to the server 10. The viewing unit 200 is configured to receive and reproduce streaming data from server 10. In some embodiments, a user may activate the streaming unit 100 when broadcasting or activate the viewing unit 200 when watching streaming respectively. In some embodiments, the user terminal who is activating the streaming unit 100 may be referred to as a livestreamer or be referred to as the user terminal which generates the streaming data. The user terminal who is activating the viewing unit 200 may be referred to as a viewer or be referred to as the user terminal which reproduces the streaming data.

The streaming unit 100 may include video control unit 102, audio control unit 104, distribution unit 106 and UI control unit 108. The video control unit 102 may be connected to a camera (not shown) and the video is controlled by the camera. The video control unit 102 may obtain the video data from the camera. The audio control unit 104 may be connected to a microphone (not shown) and the audio is controlled by the microphone. The audio control unit 104 may obtain the audio data from the microphone.

The distribution unit 106 receives streaming data, which includes video data from the video control unit 102 and audio data from the audio control unit 104, and transmits to the server 10 via network NW. In some embodiments, the distribution unit 106 transmits the streaming data in real-time. In other words, the generation of the streaming data from the video control unit 102 and audio control unit 104, and the distribution of the distribution unit 106 is performed simultaneously.

UI control unit 108 controls the UI for the livestreamer. The UI control unit 108 is connected to a display (not shown) and is configured to generate the streaming data to whom the distribution unit 106 transmits, reproduces and displays the streaming data on the display. The UI control unit 108 shows the object for operating or the object for instruction-receiving on the display and is configured to receive the tap input from the livestreamer.

The viewing unit 200 may include UI control unit 202, rendering unit 204, input transmit unit 206. The viewing unit 200 is configured to receive streaming data from server 10 via network NW. The UI control unit 202 controls the UI for the viewer. The UI control unit 202 is connected to a display (not shown) and/or speaker (not shown) and is configured to display the video on the display and output the audio from the speaker by reproducing the streaming data. In some embodiments, Outputting the video on the display and audio from the speaker may be referred to as “reproducing the streaming data”. The UI control unit 202 may be connected to an input unit such as touch panel, keyboard or display or the like to obtain input from the users.

The rendering unit 204 may be configured to render the streaming data from the server 10 and the frame image. The frame image may include user interface objects for receiving input from the user, the comments inputted by the viewers and the data received from the server 10. The input transmit unit 206 is configured to receive the user input from the UI control unit 202 and transmit to the server 10 via the network NW.

In some embodiments, the user input may be clicking an object on the screen of the user terminal such as selecting a live stream, entering a comment, sending a gift, following or unfollowing an user, voting in an event, gaming or the like. For example, the input transmit unit 206 may generate gift information and transmit to server 10 via the internet NW if the user terminal of the viewer clicks a gift object on the screen in order to send a gift to the livestreamer.

In some embodiments, the user terminal 20 may include a terminal side gift DB (not shown). The terminal side gift DB is configured to store the gift information of the user terminal 20 or 30. The terminal side gift DB may include gift ID, icon ID, effect data ID and final update date. The gift ID may identify the gift. The Icon ID may be the icon data of the gift object. The effect data ID may identify the data realizing the effect corresponding to the gift. The final update date may identify the final update date of the gift.

In some embodiments, the viewer may download the gift in advance or download the gift when sending gifts. In some embodiments, gift information may be downloaded and stored in the terminal side gift DB in advance. In some embodiments, the terminal side gift DB may include the gift list corresponding to the gift list provided by the server 10. In some embodiments, the gift list in the terminal side gift DB may be synchronized with the server 10 periodically or by an operation from the user.

FIG. 3 is a schematic block diagram of the server 10 according to some embodiments of the subject application. The server 10 may include streaming info unit 302, relay unit 304, processing unit 306, stream DB 320, user DB 322, gift DB 324, event DB 326, context DB 328 and ML model 330.

The streaming info unit 302 receives the request of live streaming from the user terminal 20 of the livestreamer via the network NW. Once receiving the request, the streaming info unit 302 registers the information of the live streaming on the stream DB 320. In some embodiments, the information of the live streaming may be the stream ID of the live streaming and/or the livestreamer ID of the livestreamer corresponding to the live streaming.

Once receiving the request of providing the information of the live streaming from the viewing unit 200 of the user terminal 30 from the viewer via the network NW, the streaming info unit 302 refers to the stream DB 320 and generates a list of the available live streaming.

The streaming info unit 302 then transmits the list to the user terminal 30 via the network NW. The UI control unit 202 of the user terminal 30 generates a live streaming selection screen according to the list and displays the list on the display of the user terminal 30.

Once the input transmit unit 206 of the user terminal 30 receives the selection of the live streaming from the viewer on the live streaming selection screen, it generates the streaming request including the stream ID of the selected live streaming and transmits to the server 10 via the network. The streaming info unit 302 may start to provide the live streaming, which is specified by the stream ID in the streaming request, to the user terminal 30. The streaming info unit 302 may update the stream DB 320 to add the viewer’s viewer ID of the user terminal 30 to the livestreamer ID of the stream ID.

The relay unit 304 may relay the transmission of the live streaming from the user terminal 20 of the livestreamer to the user terminal 30 of the viewer in the live streaming started by the streaming info unit 302. The relay unit 304 may receive the signal, which indicates the user input from the viewer, from the input transmit unit 206 while the streaming data is reproducing. The signal indicating the user input may be the object-designated signal which indicates the designation of the object shown on the display of the user terminal 30. The object-designated signal may include the viewer ID of the viewer, the livestreamer ID of the livestreamer, who delivers the live streaming the viewer is viewing, and object ID specified by the object. If the object is a gift or the like, the object ID may be the gift ID or the like. Similarly, the relay unit 304 may receive the signal indicating the user input of the livestreamer, for example the object-designated signal, from the streaming unit 100 of the user terminal 20 while the streaming data is reproducing.

The processing unit 306 is configured to handle the interaction data in the live streaming room. The interaction data may be any possible parameters in the live streaming room, for example, the comments from viewers, the respective or total gifts from each or all viewers, the receiving points of the streamer, the event or campaign the streamer is participating in, the voting, the purchase, the game score, the PK status or the like. The processing unit 306 may detect a specific condition from the interaction data. The condition may be, for example, a specific amount of gifting from each or all viewers to the livestreamers, sales quantity or revenue for each product or all products, win or lose in a PK competitor, achievement of receiving points or ranking individually or in a group or the like.

In some embodiments, the processing unit 306 may detect a triggering point in the live streaming room. In some embodiments, the processing unit 306 may extract a portion of a streamer from a streaming data provided by the streamer in response to the triggering point being detected in the live streaming room. In some embodiments, the processing unit 306 may perform processing of image editing with respect to the portion. In some embodiments, the processing unit 306 may render the edited portion on the streaming data.

In some embodiments, the processing unit 306 may monitor the situation of the live streaming room. For example, the processing unit 306 may monitor the status of receiving points or ranking of the streamer with respect to the time during the period of the event. The status may include, for example, the rank of the livestreamer with respect to the time, the reward threshold, the end time of the event or the like. In some embodiments, the processing unit 306 may monitor the status and extract a portion of the streamer to feed into the language model 330. The language model 330 may further generate an edited portion flexibly or according to a pre-setting prompt or the like.

In some embodiments, the portion to be extracted from the streamer may be a portion of the facial portion or body portion of the streamer. In some embodiments, the extracted portion may be processed or edited into another portion that includes a difference with respect to the original portion in size, age, expression or movement. For example, the difference may be a cute version, a chibi version, or an old version of the streamer on the face or body or the like.

In some embodiments, the edited portion may be a bigger head in size compared with the original head. In some embodiments, the edited portion may include a process of transformation from or to another status. For example, the edited portion may include a transformation from an egg to a human being or from a mini chibi version looking to a real looking or the like. In some embodiments, the art style of the edited portion may be line art style, exaggerated style or the like. For example, the size of the head, eyes or mouth may be much bigger than usual or the like. In some embodiments, the edited portion may be adjusted flexibly according to the practical need.

In some embodiments, the edited portion to be rendered on the streamer may last for a specific duration. For example, the duration may be 5 seconds or the like. In some embodiments, the duration may be determined by other triggering points. For example, if being out of top 10 in a leaderboard is a triggering point, and the effect, which is the edited portion, may be removed once the ranking of the streamer being back to the top 10 or the like. In some embodiments, the duration may also be determined by the streamer or viewers such as directly being removed by the streamer or being removed by the viewers via sending a gift or the like. In some embodiments, the duration of the edited portion to be rendered on the streamer may be determined flexibly according to the practical need.

In some embodiments, the condition may be over, at or lower a specific parameter such as receiving point, sales revenue or the like. In some embodiments, the condition may be a dynamic combination of above conditions. For example, the condition may be two thresholds of receiving points being over 500K and 1M respectively. For another example, the condition may be the number of viewers being over 1K, lower 1K and over 1K again. Here, the number of viewers in the live streaming room may be the condition and the number being over, lower and over again may be one example of the combination of the above the condition. In some embodiments, the condition may be determined flexibly.

In some embodiments, the processing unit 306 may be set flexibly in terminals or in Server 10 or the like. More specifically, the detection of specific conditions and the triggering of special effects may be from Server 10 or terminals. In some embodiments, Server 10 may trigger the special effects in the live streaming room automatically.

FIG. 4 shows an exemplary data structure of the stream DB 320 of FIG. 3. The stream DB 320 holds information regarding a live stream currently taking place. The stream DB 320 stores a stream ID for identifying a live- stream on a live distribution platform provided by the live streaming system 1, a livestreamer ID for identifying the livestreamer who provides the live-stream, and a viewer ID for identifying a viewer of the live-stream, in association with each other.

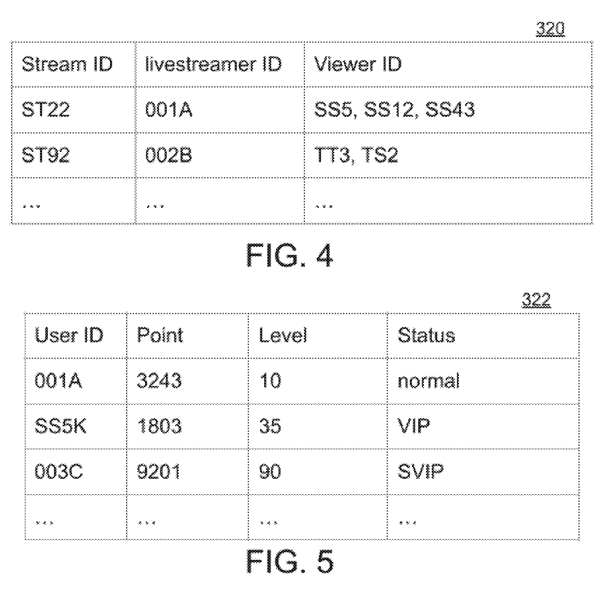

FIG. 5 shows an exemplary data structure of the user DB 322 of FIG. 3. The user DB 322 holds information regarding users. The user DB 322 stores a user ID for identifying a user, points for identifying the points the user accumulates, level for identifying the level of the user and status for identifying the status of the user in association with each other. The point is the electronic value circulated within the live-streaming platform. The level may be an indicator of the amount of user activity or engagement on the live streaming platform. The status may be an identity or membership status of the user on the live streaming platform.

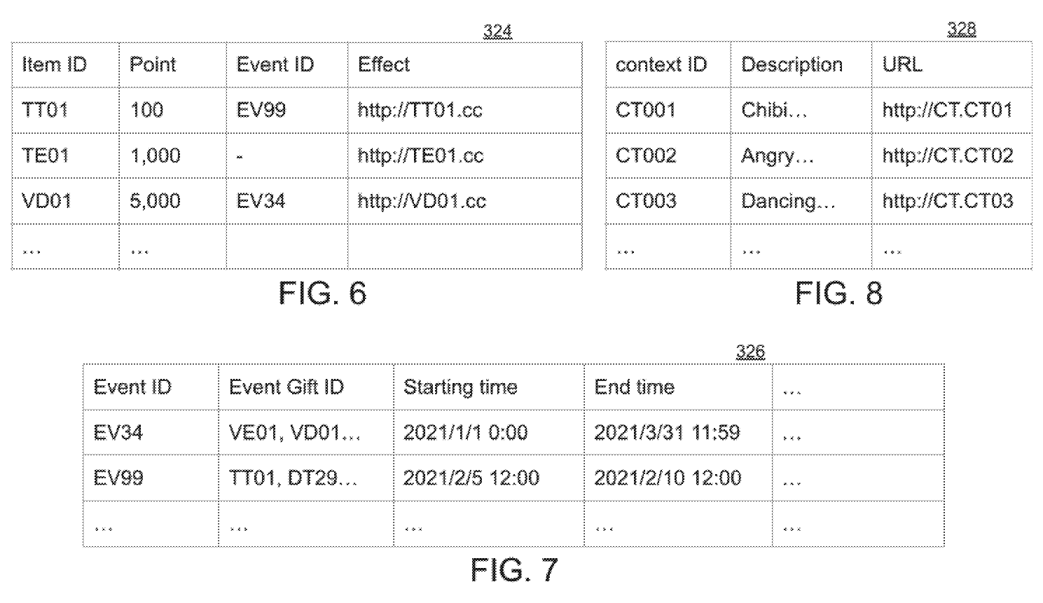

FIG. 6 shows an exemplary data structure of the gift DB 324 of FIG. 3. The gift DB 324 maintains information on gifts that can be used by the viewer in the live streaming. The gift DB 324 stores a gift ID for identifying a gift, the amount of points that the viewer spends in order to send the gift to the streamer, the event ID for identifying the event the gift is corresponding to, and the effect data for the gift, in association with each other.

The viewer can give the gift to the streamer by paying the equivalent value points for a desired gift while watching the live streaming. The payment of such equivalent value points can be made by an appropriate electronic means, for example, the viewer can pay the equivalent value points to the administrator. Alternatively, bank transfers or credit card payments can also be used. The relationship between awarded points and equivalent value points can be set arbitrarily by the administrator.

A gift is electronic data with the following characteristics:

It can be purchased in exchange for the points (later described in detail) or can be given for free.

It can be given by a viewer to a streamer. - Giving a gift to a streamer is referred to as using the gift or throwing the gift.

Some gifts may be purchased and used at the same time, and some gifts may be purchased or given and then used at any time later by the purchaser or recipient viewer.

When a viewer gives a gift to a streamer, the streamer is awarded the amount of points corresponding to the gift and an effect associated with the gift is exerted. For example, an effect corresponding to the gift will appear on the live streaming screen.

The effect is a visual or auditory or tactile effect (e.g., vibration) or a combination thereof that characterizes a gift. Examples of the visual effect include animation, images, and flashing/blinking. Examples of the auditory effect include sound effects and voice. The effect data is data for realizing such an effect on the user terminal 20, and the user terminal 20 realizes such an effect by processing the effect data. Since the technique for realizing the effect data itself is known, it will not be hereunder described in detail.

FIG. 7 shows an exemplary data structure of the event DB 326 of FIG. 3. The event DB 326 stores the information of the event the APP or platform provider is holding. The event DB 326 stores an event ID for identifying an event, the event gift ID for identifying the gift in an event, the starting time and end time for identifying the starting time and end time of the event. In some embodiments, the event DB 326 may store title for identifying title of the event, tag for identifying category or topic of the events, the event URL for identifying the location of the event page, in association with each other.

Here, the “event” may be referred to as the event for the streamer to compete with the points they received. The event may be held by the APP or platform provider. The viewers may send virtual items such as gifts to the streamers and each virtual item may be corresponding to a specific amount of points. The streamers may interact with the viewers to collect points. In the event, the streamers may be ranked according to the points they received. The streamers who received relatively high points may obtain the reward. In some embodiments, each event may include specific gifts respectively, so only specific gifts may contribute to the points the streamer received. In some embodiments, the gifts may be common to all the events. In some embodiments, the rule for the event may be designed according to the practical need.

The event may be started from the starting time and ended until the end time. The streamers who are participating in the event may compete with each other for the amount of event gift collected from the viewers during a specific time, which may be the period from the starting time to the end time. The streamer who collects the most amount of event gift may be the winner and receive a specific reward. In some embodiments, the rule of the event and the index for determining the winner may be designed flexibly.

In some embodiments, the server 10(10, 110, 210) may further include gift info unit (not shown) and gift processing unit (not shown). The gift info unit provides information on gifts to the corresponding livestreamer and viewers. The gift info unit transmits, to the livestreamer, the gift information for the terminal in response to a request from the user terminals. The gift info unit obtains, from the gift DB 324, the effect data corresponding to the gift ID included in the gift information signal that has been received by the relay unit 304. The gift info unit transmits the obtained effect data to the other user terminals 20 and 30 as a response to the gift sending request signal.

The gift processing unit updates the user DB 322 so as to update the points of the livestreamer and the viewer depending on the points of the gift identified by the gift ID included in the gift usage signal. Specifically, the gift processing unit refers to the gift DB 324 to specify the points to be granted for the gift ID included in the received gift usage signal. The gift processing unit then updates the user DB 322 to add the determined points to the points of the livestreamer ID included in the gift usage signal. In some embodiments, the gift processing unit may also update the user DB 322 to subtract the determined points from the points of the viewer ID included in the gift usage signal.

FIG. 8 shows an exemplary data structure of the context DB 328 of FIG. 3. The context DB 328 holds information regarding context data. The context DB 328 stores a context ID for identifying a context data, a description for identifying the description of the context data, and a URL identifying the location of the context data, in association with each other. In some embodiments, the context may be text object, image object, video object or the like provided by the live streaming system 1 or uploaded by the user.

In some embodiments, the context data in the context DB 328 may be the background materials or decoration materials for the portion to be edited. In some embodiments, the context may be the image or video of the livestreamers or viewers, and the image or video may be retrieved from live streaming data, archived streaming data of the livestreamer or the like. In some embodiments, the context may also be contexts uploaded from the user, provided by the live streaming system 1 or retrieved from the internet or the like. In some embodiments, the context may also be determined flexibly according to the practical need.

In some embodiments, the machine learning models 330 may be any possible machine learning models such as the content-based mode, behavior-based model, language model such as ChatGPT, image generation such as MidJourney or the like. In some embodiments, the machine learning models may infer the possible output according to the input and the procedure of digesting may refer to providing users with the inference from the models. In some embodiments, the machine learning models may generate an image or video according to the input from the live streaming room or the like.

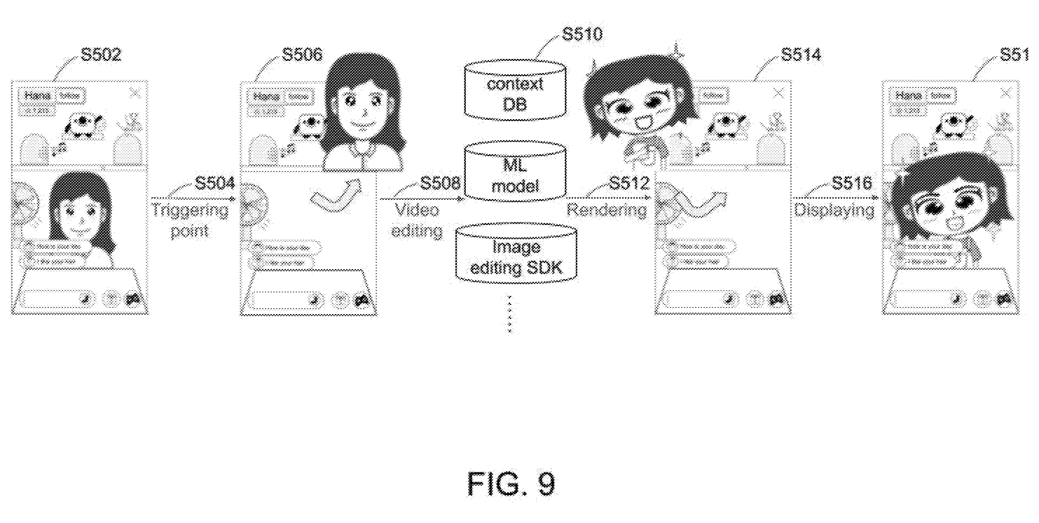

FIG. 9 is exemplary functional configuration of the live streaming system 1 according to some embodiments of subject application. As shown in FIG. 9, the livestreamer may interact with the viewers in the live streaming room (S502). In some embodiments, there may be one or a plurality of triggering points from the interaction data between the livestreamer and the viewers. Once a triggering point in the live streaming room is detected (S504), a portion of the livestreamer may be extracted from the live streaming provided by the livestreamer (S506).

Furthermore, Image processing may be performed with the extracted portion (S508). In some embodiments, the Image processing may be performed based on a pre-established database, a SDK or machine learning model with a pre-setting rules or prompt to realize the process (S510). For example, a chibi version of person may refer to a style of art or depiction where characters are drawn in a small, exaggerated, and highly stylized form, commonly with oversized heads and small bodies. A chibi version of the livestreamer may be stored in a corresponding database or be generated from a machine learning model or the like to realize the image processing.

In some embodiments, once the extracted portion is performed with the image processing, the portion after image processing may be rendered back to the streaming data (S512). Once the rendering is done(S514), the rendered streaming data may be distributed to the livestreamer and viewers for display (S516). Once the livestreamer or the viewers received the streaming data on their terminals, it may be reproduced on a screen 600 of their terminals to realize the function (S518).

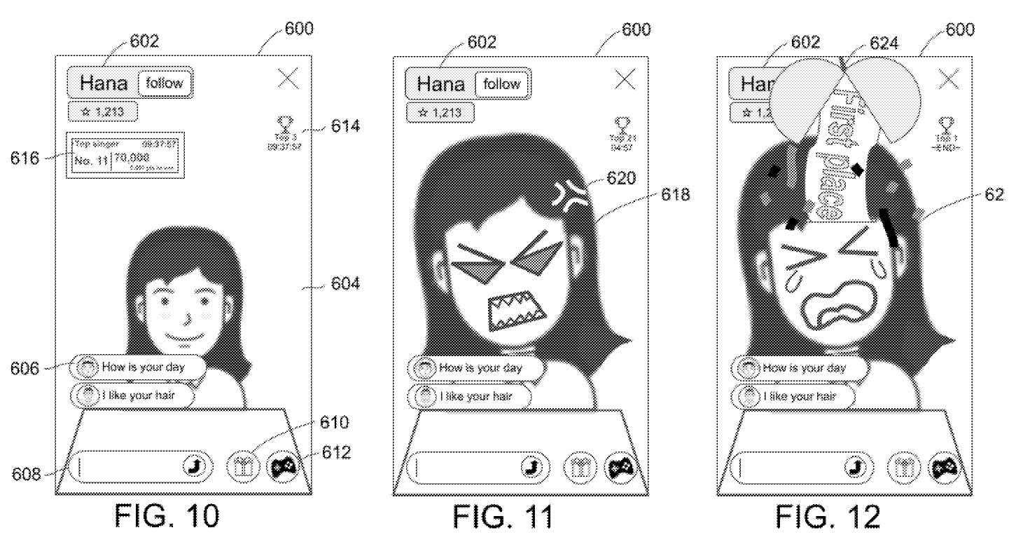

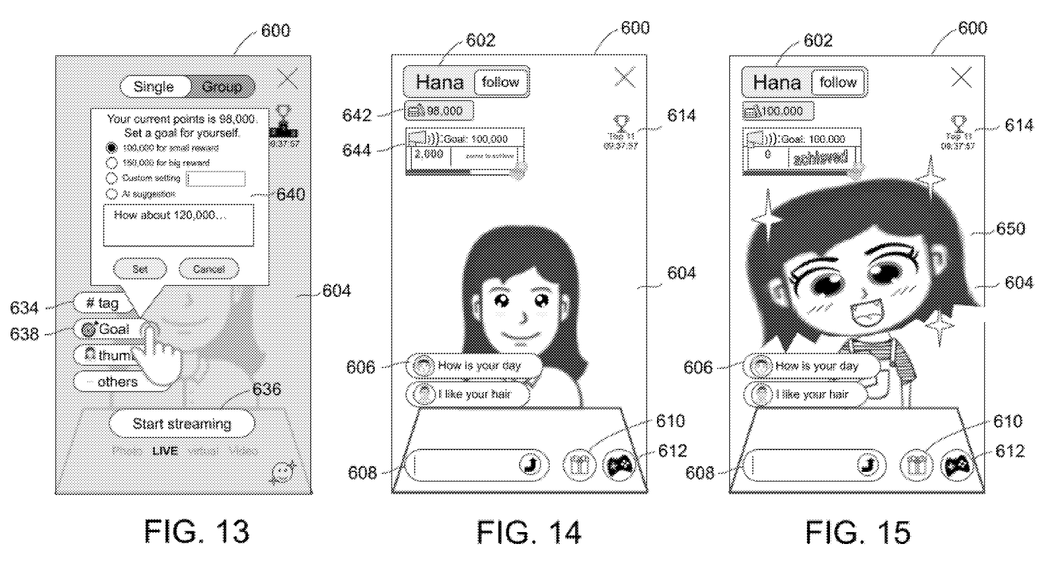

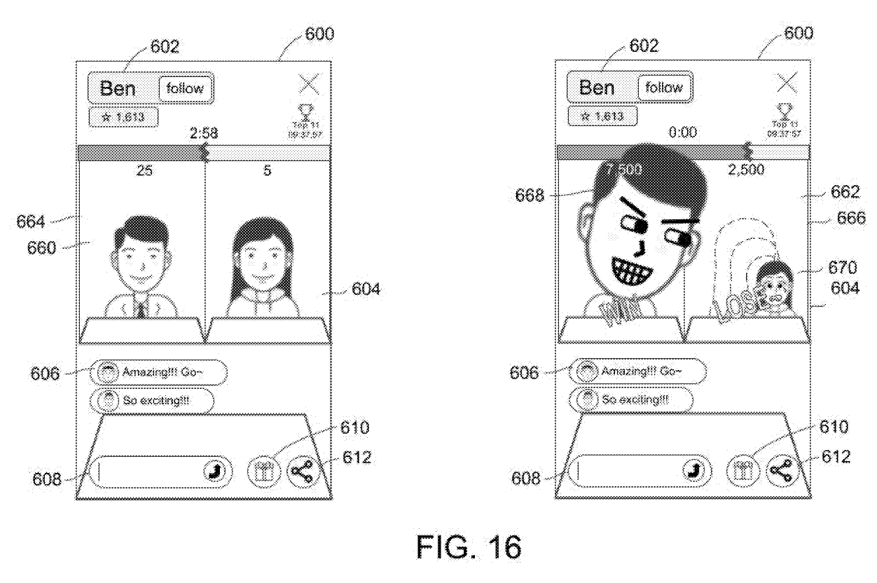

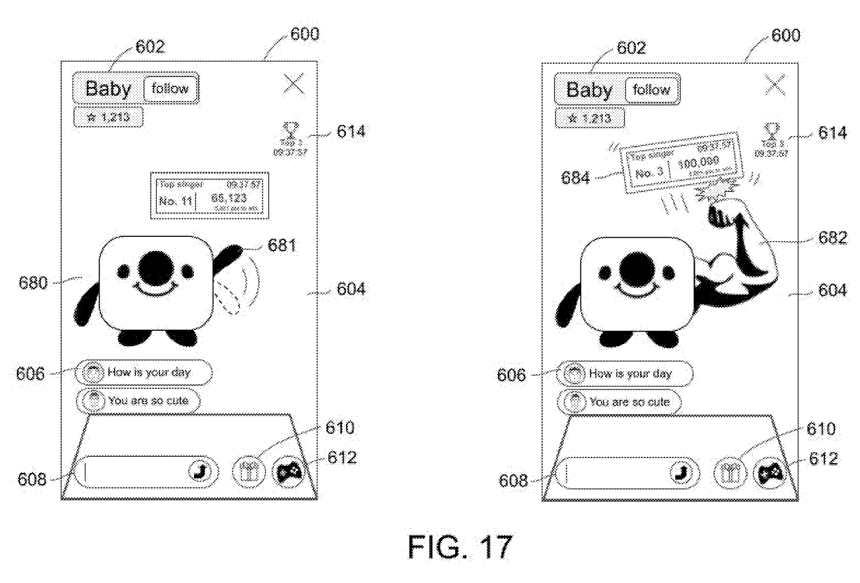

FIG. 10 - FIG. 17 are exemplary screen images of a live-streaming room screen 600 shown on the display of the livestreamer user terminal 20 or the viewer user terminal 30. Once the viewer selects and enters a live-streaming room, a live streaming room screen 600 of the livestreamer may be shown on the display. The live streaming room screen 600 may include a livestreamer info object 602, livestreamer image 604, message zone 606, message input box 608, gift object 610, sharing object (not shown) or the like.

The livestreamer info object 602 shows the information of the streamer. The livestreamer image 604 shows the image or video of the streamer and the image may be obtained by reproducing the video data. The message zone 606 shows the messages from the viewer, streamer or the server 10. The message input box 608 shows an input zone for the streamer or viewers to enter a message or the like. The gift object 610 provides the users with the function of gifting to the livestreamer and the sharing object provides the users with the function of sharing the live streaming room. In some embodiments, the UI and the related function in the live streaming room may be designed flexibly.

In some embodiments, the triggering point may be corresponding to an event the streamer is participating in. In some embodiments, any parameters related to the event may be taken as a triggering point. For example, the triggering point may include a beginning of the event, an ending of the event, a specific time period right before the ending of the event or a ranking change of the streamer in a leaderboard from the event or the like. In some embodiments, a gift item related to the event may also be a triggering point while being sent, received or the like.

In some embodiments, the live streaming room screen 600 may include an event icon 614 as shown in FIG. 10. The event icon 614 may show the event the livestreamer is currently participating in and also the remaining time of the event, the current rank or the like. In some embodiments, the livestreamer and viewers may click the event icon 614 to receive event description and current ranking. In some embodiments, once the event icon 614 is clicked, the corresponding event gift in the event may be displayed. For example, if the viewers click the event icon 614, the event gift tab in the gift list may be popped up for the viewers to send event gifts to support the livestreamer in an easier way.

As shown in FIG. 10, an event sticker 616 may also be provided on the screen 600 for the livestreamer to display the current status of the event. The event sticker 616 may include information such as the name of the event, the remaining time of the event, the current ranking, the current points or the like. In some embodiments, the event sticker 616 may also include the difference of the points of the livestreamer with the previous or the next livestreamer in the leaderboard. For example, if the livestreamer is at rank 11, and the difference of the points with livestreamers at rank 12 or rank 10 may be displayed for the livestreamer and viewers to understand the current status in the leaderboard. In some embodiments, the event sticker 616 may include any possible and helpful information for the livestreamer and viewers to understand the current situation of the event.

In some embodiments, the condition to trigger a triggering point during the event may be any possible parameters described above or the like. More specifically, the events always take place during a specific duration and the ranking of the streamer in a leaderboard would change according to the support from the viewers such as the receiving points or the like. As shown in FIG. 11, if the remaining time of the event is less than five minutes and the ranking of the streamer is still left behind, an angry face 618 or the like may be generated and rendered on the streamer to indicate the fact of that. According to the embodiments, the viewers may understand that the event approaches the final moments and they may put in extra effort to support their streamer.

In some embodiments, the event may also state that extra reward may be received if the livestreamer’s ranking is achieved a threshold such as top 10 or the like. Once the ranking of the streamer drops from the top 10 to outside the top 10, the angry face 618 as shown in FIG. 11 or the like may also be generated and rendered on the streamer to indicate the fact of that. In some embodiments, the angry face 618 may be a normal size or an exaggerated size compared to the original face size of the streamer or the like. In some embodiments, a decoration object such as the angrily bursting veins 620 may further be added to emphasize the exaggeration of angry or the like.

In some embodiments, the end of the event may be taken as a triggering point. The event is highly competitive, especially as it approaches the final moments, as many viewers tend to swoop in and make large donations to support their favorite streamer, aiming to secure their victory. As shown in FIG. 12, if the event ends and the streamer win the top 1, a happy face or a face of tears with joy 622 may be generated and rendered on the streamer to indicate the fact of that. Moreover, a decoration object such as the congratulation ball 624 may further be added to emphasize the celebration of the victory or the like. Conversely, if the event ends and the streamer doesn’t achieve first place or the like, a crying face may be generated and rendered on the streamer. According to the embodiments, the viewers may understand that if their favorite streamer wins the event from the rendered expression or the like.

In some embodiments, the triggering point may be corresponding to a receiving point of the streamer from the interaction with viewers in the live streaming room. In some embodiments, the triggering point may include the receiving point being achieved a whole number ending in zeros. In some embodiments, the triggering point may include the receiving point being achieved a threshold value determined by the streamer, viewers, Server 10 or the like. In some embodiments, the mechanism of the triggering point may be determined flexibly.

In some embodiments, the streamer may set the threshold value before or during the live streaming. In some embodiments, the streamer may set the threshold value in a broadcasting schedule, which refers to a schedule of a live streaming in the future or the like. FIG. 13 shows an example of a threshold value determined by the streamer. As shown in FIG. 13, the live streaming setting screen 600 may include pre-setting button 634, streamer image 604, streaming button 636 and so on. The pre-setting button 634 may include all the pre-setting buttons for the live streaming such as setting tags, selecting events, changing thumbnail, setting filters or the like. The streamer image 604 may be obtained by reproducing the video data. The streaming button 636 may be the button to be clicked to start the live streaming.

In some embodiments, the streamer may set the threshold value in the pre-setting button 634 such as the goal button 638. Once the goal button 638 is clicked, an UI interface 640 may be displayed for the streamer to set the threshold. As shown in the UI interface 640 in FIG. 13, the streamer may select a goal by default or determined by themselves or a suggestion from an AI model or the like. In some embodiments, the goal may be to achieve a receiving point, achieve a ranking in a leaderboard or any possible goal to be set in the live streaming room. Once the goal is set, the streamer may click the set button to finalize the goal setting.

In some embodiments, the triggering point corresponding to the receiving point of the streamer may also be triggered automatically from Server 10. As shown in FIG. 14, the streamer may receive gifts corresponding to a point of 98,000 in total according to the point receiving object 642. In some embodiments, the whole number ending in zeros and is closest to the 98,000 is, for example, 100,000, so the receiving point of 100,000 may be set as a threshold value by the streamer or be set automatically by Server 10 or the like.

As shown in FIG. 13 and 14, a goal sticker 644 may also be provided on the screen 600 for the livestreamer to display the status of the goal. The goal sticker 644 may include information such as the description of the goal, the remaining points to achieve the goal, the current receiving point or the like. In some embodiments, the goal sticker 644 may also include the visualized UI status for the users to check the progress of the goal and the reward or the like. Once the goal is completed, the streamer may claim the reward by clicking it or the like. In some embodiments, the mechanism of the goal sticker 644 may be determined flexibly.

In some embodiments, the condition to trigger a triggering point during receiving points from the viewers may be any possible parameters described above or the like. As shown in FIG. 15, if the threshold value of 100,000 is achieved, a chibi version 650 of the streamer or the like may be generated and rendered on the streamer to indicate the fact of that. According to the embodiments, it may motivate the viewers to help the streamer to achieve the goal in order to watch the special effects rendered on the streamer, and the interaction in the live streaming room may also be improved.

In some embodiments, the livestreamer may have a group call or PK with other livestreamers to have a multi-user interaction. FIG. 16 shows an example of having a PK with the other livestreamer in the live streaming room. In some embodiments, the condition may be any possible triggering point in the live streaming room such as the beginning or end of the PK, the win or lose of the PK, the difference of the PK score achieving a threshold or the like.

As shown at the left side in FIG. 16, one livestreamer may initiate a PK interaction with the other livestreamer, and the viewers may send the gift to support their favorite livestreamer. In some embodiments, if the PK time is over and one livestreamer receives more gifts than the other livestreamer, it may be understood that the livestreamer beats the other livestreamer and wins the PK. As shown at the right side in FIG. 16, a special effect may be generated and rendered on the livestreamer or the other livestreamers to indicate the result of the PK or the like.

More specifically, once a multi-user interaction such as the PK is launched, the streaming data may be rendered including the streamer 660 and another streamer 662 as shown in FIG. 16. In some embodiments, the streamer 660 may be in a first frame 664 and another streamer 662 is in a second frame 666 respectively. In some embodiments, the edited portion such as the big head 668 of the streamer 660 may be rendered to overlap on the first frame 664 and on the second frame 666. In some embodiments, edited portions such as the size 670 of another streamer 662 may be reduced and be gradually smaller to generate an atmosphere of the other streamer 662 lose the PK or the like. According to the embodiments, it may bring more fun and excitement to the PK competitor and the user experience may be improved.

In some embodiments, the streamer may be a real person. The real person may provide streaming data by capturing the video data and audio data from the camera or microphone in the user terminal. In some embodiments, the streamer may be a virtual avatar controlled by the real person. The real person may set a virtual avatar or virtual skin representing the streamer and provide the audio data from the microphone only in the user terminal.

In some embodiments, the streamer may be a virtual avatar with an AI machine learning model, which may be referred to as an AI virtual livestreamer. The virtual avatar may be set in advance or generated by an AI machine learning model, and the interaction in the live streaming room may be realized based on a machine learning model. For example, the comment from viewers may be retrieved from the live streaming room, and then fed into the machine learning model to generate a response on the comment and then transmit the response to the live streaming room. According to the embodiments, the interaction between the AI virtual livestreamer and the viewers may be realized smoothly.

FIG. 17 shows an example of a streamer having a virtual avatar. In some embodiments, the streamer having a virtual avatar may be a real person or AI virtual livestreamer or the like. In some embodiments, the appearance of the virtual avatar may be a human-like image or other possible object such as the doll 680 as shown in FIG. 17. In some embodiments, once a triggering point is triggered, a portion of the streamer may be extracted and an image processing may be performed on the extracted portion. In some embodiments, a body movement or facial expression may also be a triggering point such as the waving arm 681 as shown in FIG. 17.

In some embodiments, the extracted portion may be performed with an image processing according to a pre-setting database, an image editing software or an AI machine learning model or the like. As shown in FIG. 17, if a triggering point is triggered, a strong arm 682 or the like may be generated and rendered on the arm 681 of the AI virtual livestreamer or the like. According to the embodiments, the fun in the live streaming room may be improved.

Furthermore, the position and the coverage area of the edited portion may also be detected. In some embodiments, if the position and the coverage area of the edited portion would overlap with any possible UI object on the screen 600, the position or the coverage area of the UI object may be changed or the like. As shown in FIG. 17, if the strong arm 682 overlaps with the sticker 684 in position, the position of the sticker 684 may be shifted upward to create the feeling of a sticker being moved or slapped on or the like. According to the embodiments, the fun in the live streaming room may be improved.

In some embodiments, a gift item for general usage or for specific scenarios such as the event, PK or the like may also be a triggering point once a viewer sent the gift item or the like. For example, a special gift item used in a PK may trigger the increase of the size of the face for a predetermined time or the like. In some embodiments, the triggering point may be applied in a live commerce event. For example, the condition may be any possible triggering point during the live commerce event such as number of products sold for each type of product or total products, sales revenue for each type of product or total products, the number of viewers in the live streaming room, the number of like from the viewers or the like.

In some embodiments, the edited portion to be rendered on the streamer may vary according to the proximity to the goal or triggering point. For example, if the receiving point approaches the goal point, the face to be rendered on the streamer may be bigger and bigger or the like. In some embodiments, the change on the streamer may not only be like the edited portion, but also includes the process of changing or the like. In some embodiments, the mechanism of the triggering point and the corresponding effect on the streamer or the other object on screen 600 may be determined flexibly according to the practical need.

In some embodiments, the triggering point may be any possible parameters in the live streaming room. In some embodiments, the triggering point may be a specific face expression or body movement from the streamer. More specifically, the face expression or body movement from the streamer may be detected periodically, and if a specific face expression or body movement is detected, an edited portion such as an exaggerated and huge face may be generated and rendered on the streamer.

In some embodiments, a detecting unit (not shown) may be provided to detect the streamer image 604 and the edited portion may be rendered in response to a face expression or body movement from the streamer being detected. In some embodiments, the streamer may frown, grin, waving hands or the like to indicate the triggering point. In some embodiments, the audio input or the image input such as facial feature or gesture may be determined in advance or in real-time. In other words, the APP or platform provider may set up a rule or look-up table for how to generate the edited portion according to audio input or the image input. In some embodiments, the user may also set up by themself.

In some embodiments, the triggering point may be a specific number of comments or a specific keyword in the comment or the like from the viewers. In some embodiments, the triggering point may be determined flexibly according to the practical need. In some embodiments, the triggering point, the generation of edited portion and the timing for rendering the edited portion may also be determined or designed flexibly.

According to the present disclosure, it may motivate the viewers to have more interaction with the livestreamer. Moreover, it may add more fun to the live streaming room, and also make the interaction in the live streaming room smoother. Therefore, the user experience may be improved.

In some embodiments, the present disclosure may include the following embodiments:

1. A server including a circuitry, wherein the circuitry is configured to perform: detecting a first triggering point in the live streaming room; extracting a first portion of a streamer from a streaming data provided by the streamer in response to the first triggering point in the live streaming room being detected; performing processing of image editing with respect to the first portion; and rendering the edited first portion on the streaming data.

2. The server according to embodiment 1, wherein: the triggering point is corresponding to an event the streamer is participating in; and the triggering point includes a beginning of the event, an ending of the event, a specific time period right before the ending of the event or a ranking change of the streamer in a leaderboard from the event.

3. The server according to embodiment 1, wherein: the triggering point is corresponding to a receiving point of the streamer from the interaction with viewers in the live streaming room; and the triggering point includes the receiving point being achieved a whole number ending in zeros or achieved a threshold value determined by the streamer.

4. The server according to embodiment 1, wherein: the first portion is corresponding to a facial portion or body portion of the streamer; and the edited first portion includes a difference with respect to the first portion in size, age, expression or movement.

5. The server according to embodiment 1, including: generating a multiple user interaction streaming including the streamer and another streamer; wherein the streamer is located in a first frame and the another streamer is located in a second frame; and the edited first portion is overlapped on the first frame and on the second frame.

6. The server according to embodiment 1, including: detecting a position of a first object; and changing the position of the first object in response to the edited first portion being overlapped with the first object.

7. The server according to embodiment 1, wherein: the triggering point is corresponding to a gift item sent by a viewer in response to receiving a signal from the viewer terminal indicating use of the gift item by the viewer; and the gift item is a general gift item or gift item for a multiple user interaction, an event the streamer is participating in or a game the streamer is playing.

8. The server according to embodiment 1, wherein: the edited first portion is processed from a pre-setting database, an image editing software or an AI machine learning model; and the streamer is a real person, a virtual avatar with the real person or the virtual avatar with the AI machine learning model.

9. A method, including: detecting a first triggering point in the live streaming room; extracting a first portion of a streamer from a streaming data provided by the streamer in response to the first triggering point in the live streaming room being detected; performing processing of image editing with respect to the first portion; and rendering the edited first portion on the streaming data.

10. A computer program for causing a server to realize the functions of: detecting a first triggering point in the live streaming room; extracting a first portion of a streamer from a streaming data provided by the streamer in response to the first triggering point in the live streaming room being detected; performing processing of image editing with respect to the first portion; and rendering the edited first portion on the streaming data.

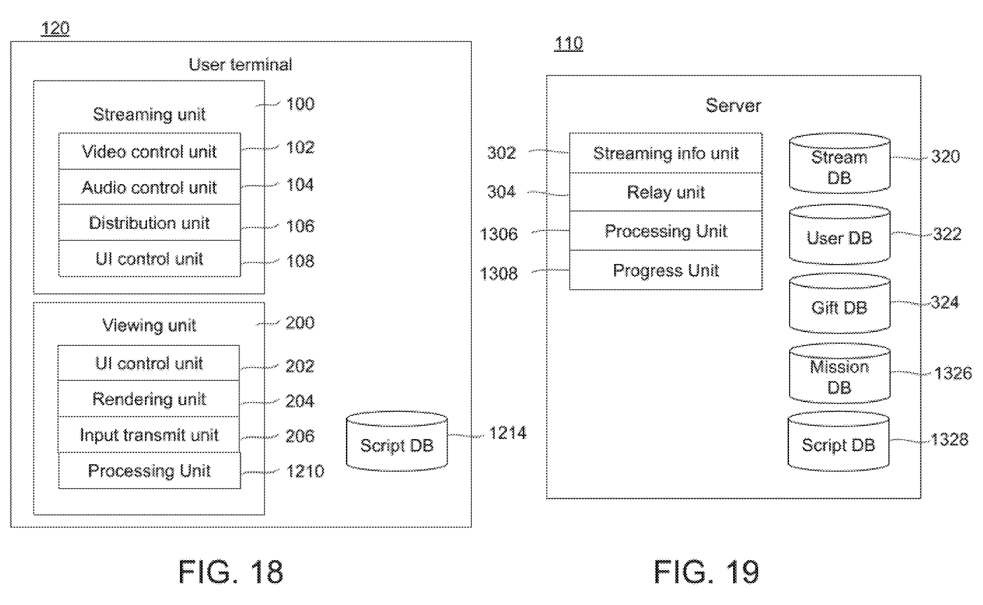

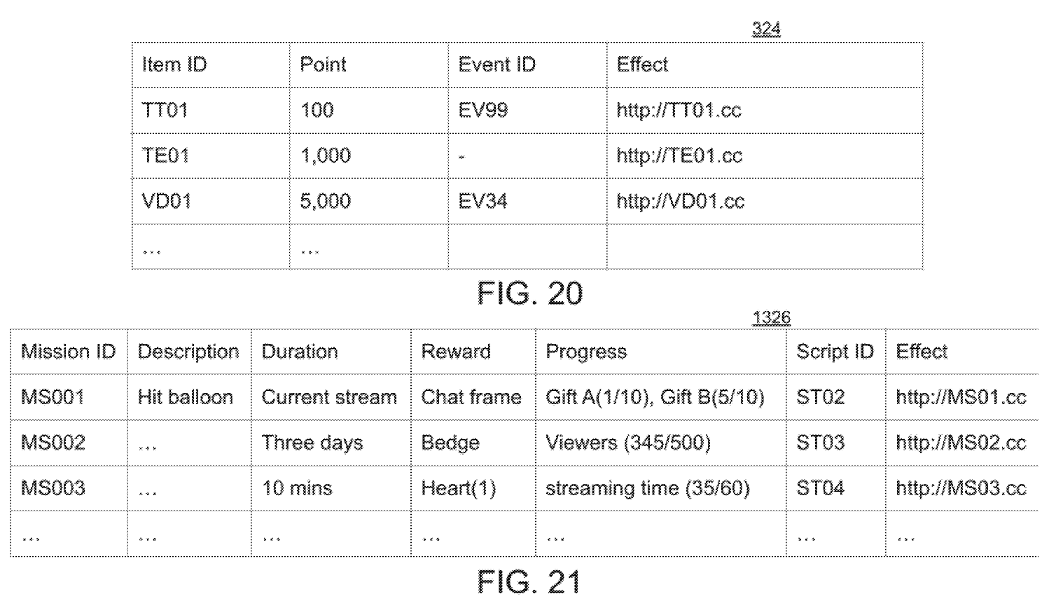

FIG. 18 is a block diagram showing a function and configuration of the user terminal 120 in FIG. 1 according to the embodiment of the present disclosure. FIG. 19 is a schematic block diagram of the Server 110 according to some embodiments of the subject application. The elements with the same element numbers may refer to that in FIG. 2 and FIG. 3, and are not described herein.

The viewing unit 200 may include UI control unit 202, rendering unit 204, input transmit unit 206 and processing unit 1210. In some embodiments, the processing unit 1210 may check whether the script DB or the gift DB is the latest database or is there enough script or gift to realize the execution or not. In some embodiments, if the script may be played, the processing unit 1210 may further detect the execution from the user terminal of the user. In some embodiments, the database of the script may be set in Server 110 or in user terminal or the like. In some embodiments, the user terminal may realize the script according to the script DB 1214 or the Server 110 may cause the user terminal to realize the script according to the script DB 1214, script DB 1328 or the like. In some embodiments, the setting of the script database may be determined flexibly.

In some embodiments, the script retrieved from the script DB 1214 may be performed according to the triggering action described in the script. For example, the script of ST02-01 ~ ST02-04 corresponds to the triggering action of an effect of ET010 ~ ET012 and CB001 or the like, and the processing unit 1210 may display the corresponding effect of ET011 in response to the triggering event of the script being triggered.

FIG. 19 is a schematic block diagram of the Server 110 according to some embodiments of the subject application. The Server 110 may include streaming info unit 302, relay unit 304, processing unit 1306, progress unit 1308, stream DB 320, user DB 322, gift DB 324, mission DB 1326 and script DB 1328.

In some embodiments, the processing unit 1306 may provide information such as the gift DB 324 and script DB 1328 or the like to the corresponding livestreamer and viewers. In some embodiments, the processing unit 1306 transmits information of the gift DB 324 and script DB 1328 or the like to the user terminal either proactively or upon receiving an update request. In some embodiments, the processing unit 1306 obtains, from the gift DB 324 and script DB 1328, the information of the gift item or script and transmits the obtained information to the user terminals 120 and 30 voluntarily or as a response to the update request signal from the user terminal.

The progress unit 1308 is configured to handle the progress of the, for example, accumulation in an event, mission or the like. In some embodiments, the accumulation may be any possible parameters in the live streaming room such as the type or number of the virtual gift, number of followers, broadcasting or watching duration or the like. In some embodiment, once an accumulation requirement is met, the progress unit 30 may notify the processing unit 1306 for the following procedure such as triggering an action or distributing reward or the like. In some embodiments, the function of the processing unit 1306 and progress unit 1308 or the like may also be set in the terminal side and then synchronized with the Server 110 afterward or may be determined flexibly according to the practical need.

FIG. 20 shows an exemplary data structure of the gift DB 324 of FIG. 19, and may refer to the gift DB 324 in FIG. 6. FIG. 21 shows an exemplary data structure of the mission DB 1326 of FIG. 19. The mission DB 1326 holds information regarding a mission in the live streaming platform. The mission DB 1326 stores a mission ID for identifying a mission, a description, duration, reward, progress or the like for identifying the description, duration, reward, progress or the like of the mission, in association with each other. In some embodiments, a script ID or more than one script ID related to the mission may also be stored for identifying the script to be executed before, during or after the mission. In some embodiments, an effect related to the mission may also be stored for identifying the effect to be used in the mission or the like.

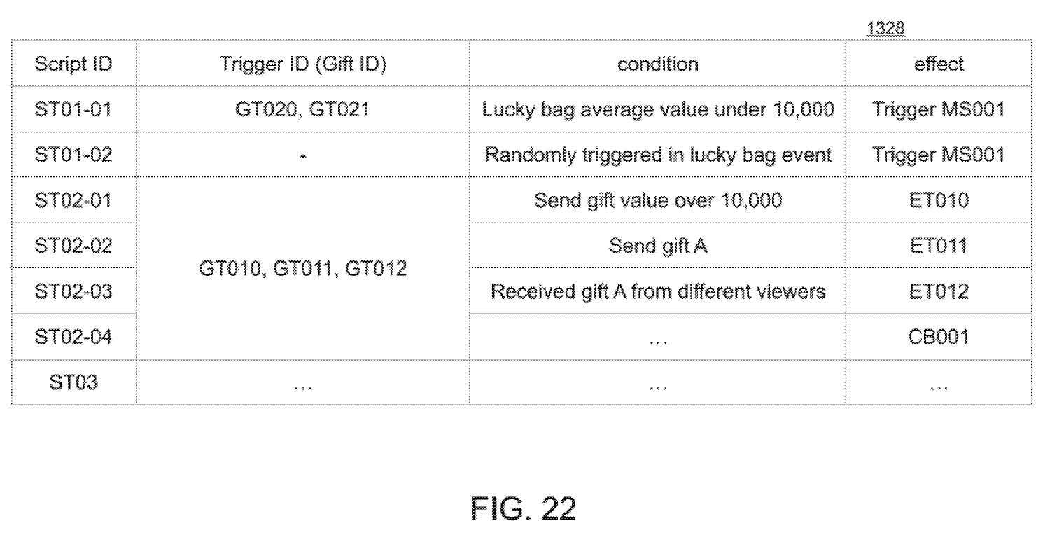

FIG. 22 shows an exemplary data structure of the script DB 1214 of FIG. 18 and script DB 1328 of FIG. 19. The script DB 1214 holds information regarding a script of the triggering event with respect to a triggering action. The script DB 1214 stores a script ID for identifying a script, trigger ID for identifying a triggering event, condition for identifying a condition at the triggering event and triggering action for identifying an action to be triggered in response to the triggering event, in association with each other.

In some embodiments, the triggering action may be to trigger another script, to trigger another mission or combination thereof. For example, the script of ST01-01 may correspond to triggering MS001, which may be the mission ID of a mission described in FIG. 21. In some embodiments, one or one more script may be triggered separately or in a related manner. More specifically, another script may be triggered if one script is triggered.

In some embodiments, Server 110 may further include an event DB (not shown). The event DB holds information regarding events on a live distribution platform provided by the live streaming system 1. The event DB stores an event ID for identifying an event, title for identifying title of the event, tag for identifying category or topic of the events, the period for identifying the starting time and end time of the event, the gift ID for identifying the gift in an event, the event URL for identifying the location of the event page, in association with each other.

In some embodiments, the live streaming platform would hold a lot of events to motivate the interaction between the streamers and viewers. The event may be for the streamers to collect virtual gifts from viewers in order to receive the rewards from the live streaming platform or the like. In some embodiments, the monitoring of the events and the triggering of the mission may also be realized by the processing unit 1306, progress unit 1308 and the databases in the user terminals and Server 110 or the like.

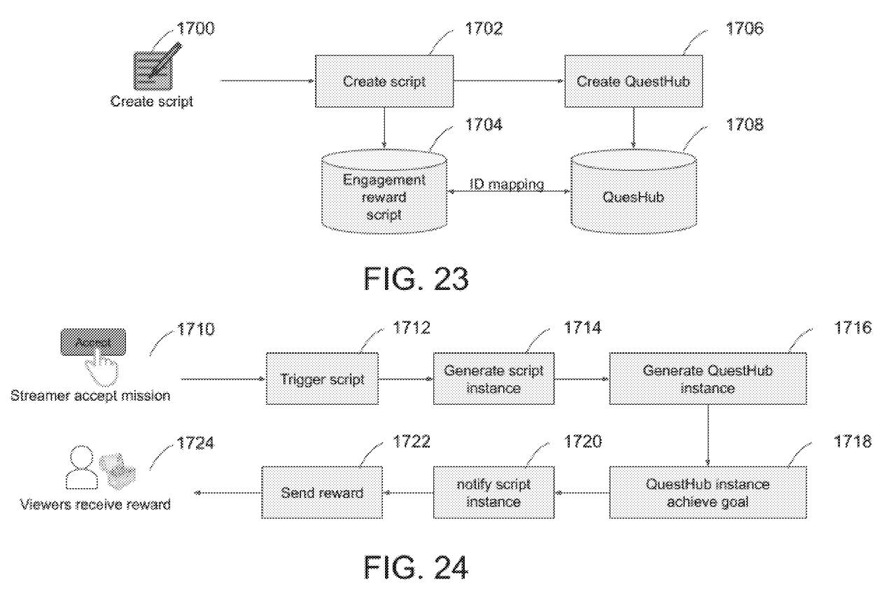

FIG. 23 - 24 are exemplary functional configurations of the live streaming system 1 according to some embodiments of subject application. As shown in FIG. 23, the rules of the events and missions may be determined in advance. In some embodiments, the rules may be the conditions for the viewers to send the virtual gifts. For example, the gifts may be general gifts or specific gifts, the gifts must be sent by one viewer or more than one viewer, which is for the viewers to collaborate to help the streamers, or the like. In some embodiments, the rules may include the virtual gifts the streamers have to collect, the rewards from the live streaming platform, the condition for achieving the events or mission, the way to display the progress to the users or the like.

In some embodiments, the scripts may be used to control the condition for the mission, the distribution of the reward in the mission or the like. More specifically, the events or missions are for users in specific regions or not, the duration of the events or missions such as no time limitation or only during the current live streaming room or the like. For example, the events or missions may be triggered in the current streaming room and the missions would be failed once the live streaming is ended or the like.

In some embodiments, the conditions for triggering the missions in an event may be determined flexibly. For example, the condition may be a combo gift sending scenario for one viewer to send gifts over a specific threshold or a milestone gift sending scenario for one or several viewers to accumulate gifts over a specific threshold or the like. In some embodiments, the rewards may be determined flexibly such as an animation in the live streaming room, virtual rewards such as chat frames or badges, virtual gifts with unique appearance or the like.

In some embodiments, one script may be corresponding to one or more than one event or missions. In some embodiments, several scripts may be combined together to generate a brand-new missions or combination of missions or the like. For example, script A may be generated by combining the script B and script C, and once the missions in the script B and script C are achieved and the rewards are distributed, the mission and reward in script A may also be achieved and distributed. According to the embodiments, the events, missions and the execution thereof may be more flexible and the rewards to the users may be also increased, which may motivate them to interact more in the live streaming room.

As shown in FIG. 23, once the script for the events or missions is determined (1700), the processing unit 1306 may create or generate a script accordingly (1702). For example, the rules for the engagement among the viewers and streamers or the rewards may be stored in the corresponding columns in an engagement reward database such as the mission DB 1326, script DB 1328, event DB or the like.

In some embodiments, the condition for the accumulation of virtual gifts may also be created or generated accordingly for monitoring the achievement of the events or missions or the like (1706). In some embodiments, the condition may be the rules for accumulating specific items to trigger a mission, complete a mission or the like. In some embodiments, the progress unit 1308 may monitor and store the accumulation of the virtual gifts in a QuestHub database such as the mission DB 1326, event DB or the like (1708).

In some embodiments, the situation of the QuestHub database and engagement reward database may be mapped with each other via ID such as the event ID, mission ID, script ID or the like. Once the condition for, for example, triggering a mission or achieving a mission is detected by the progress unit 1308, the progress unit 1308 may notify the processing unit 1306 for triggering a mission, distributing a reward or the like.

In some embodiments, the QuestHub database is configured to store the accumulation of the virtual items or the like for the progress unit 1308 to monitor. Once the condition for the accumulation is achieved, the progress unit 1308 may notify the processing unit 1306 accordingly for the corresponding procedure or the like.

In some embodiments, the accumulation may be any possible parameters in the live streaming room such as the virtual gifts, the number of viewers or followers, the duration of the broadcasting or the like. In some embodiments, the accumulation may be without time limitation or with a starting time, ending time, resetting time for one day, one week or the like. For example, the accumulation may be monitored from the mission being triggered and until the mission being achieved or until the end of the live streaming or the like. In some embodiments, the accumulation may be from a starting value such as zero or the value when the mission being triggered, and to a specific value. Once the accumulation met the specific value, the progress unit 1308 may notify the processing unit 1306 for the following procedure or the like.

In some embodiments, the rules may be key-in manually or generated automatically via AI model or the like. In some embodiments, Server 110 may trigger the generation of the script according to the rules. Once the instruction for the generation of the script is received, Server 110 may transfer them into the corresponding engagement reward script and then stored into the corresponding column in the database. At the same time, the information about the accumulation, such as the gift number or the like, may be generated synchronously and stored in the corresponding database for data verification. In some embodiments, the progress unit 1308 may monitor the accumulation of the parameter and notify the processing unit 1306 or the like if a threshold of the accumulation is achieved or the like.

In some embodiments, once a mission is triggered in the live streaming room, the corresponding UI interface may be displayed on the user terminal of the streamer. The streamer may decide to accept or reject the mission. As shown in FIG. 24, the streamer may select to accept the mission (1710). Once the selection of a mission is accepted, the corresponding script may be triggered (1712). Furthermore, an instance for the script may be generated accordingly to handle the control of the script (1714). At the same time, an instance for the Questhub, which is to monitor the accumulation of the parameter, may be generated accordingly (1716).

In some embodiments, the instance for the Questhub, which may be progress unit 1308, may monitor the accumulation of the parameter. Once the goal of the accumulation is achieved (1718), the progress unit 1308 may notify the script instance, which may be processing unit 1306, for the following procedure (1720). In some embodiments, the following procedure may be, for example, distributing a reward to the viewers or triggering another mission or the like (1722). Once the users received the rewards (1724), the mission may disappear and the streamer may keep broadcasting or the like. In some embodiments, the mechanism of triggering or achieving the mission may be determined flexibly according to the practical need.

In some embodiments, the script and QuestHub instance is generated according to the script rule, QuestHub rule or the like. In some embodiments, the QuestHub instance may be generated for each streamer, viewer or the like. In some embodiments, the QuestHub instance may record and store, for example, the progress, reward status or the like for each user.

In some embodiments, the script and the QuestHub instance may be corresponding to each other one by one. In some embodiments, the script and the QuestHub instance may be corresponded according to an ID number such as the script ID, mission ID or the like. In some embodiments, the progress unit 1308 may monitor the achievement of the mission during the mission. Once the mission is completed or failed, the progress unit 1308 may notify the processing unit 1306 accordingly.

In some embodiments, the steps of 714, 720 and 722 may be realized via the processing unit 1306 and the setup of 716 and 718 may be realized via the progress unit 1308. In some embodiments, the generation of the script and mission and the distribution of the reward may be realized in Server 110, and the execution of the script and mission may be realized in the user terminal or the like. In some embodiments, the mechanism above may be adjusted flexibly according to the practical need.

In some embodiments, the livestreamers may have a performance to cheer up the viewer and the viewer may send gifts to support the livestreamers. However, the donation in the live streaming room is always made by some limited viewers, which means that always the same people dominate the leaderboard. Furthermore, the gift sending is always repetitive and boring. Therefore, a different way of gift sending may be necessary for the viewers to collaborate and send gifts to the streamer.

In some embodiments, a collaborative mission may be provided by the platform. The collaborative mission may be realized by more than one viewer. In some embodiments, the mission may be triggered randomly or based on a specific scenario being triggered. According to the embodiments, the random appearance of the mission without the users’ expectations may encourage viewers in the live streaming room to work together to collect specific gifts.

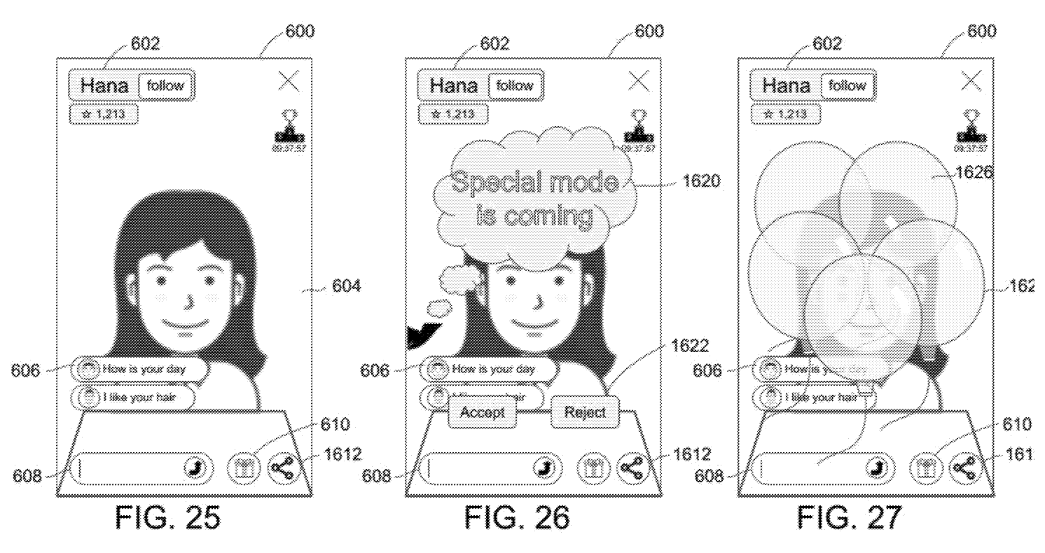

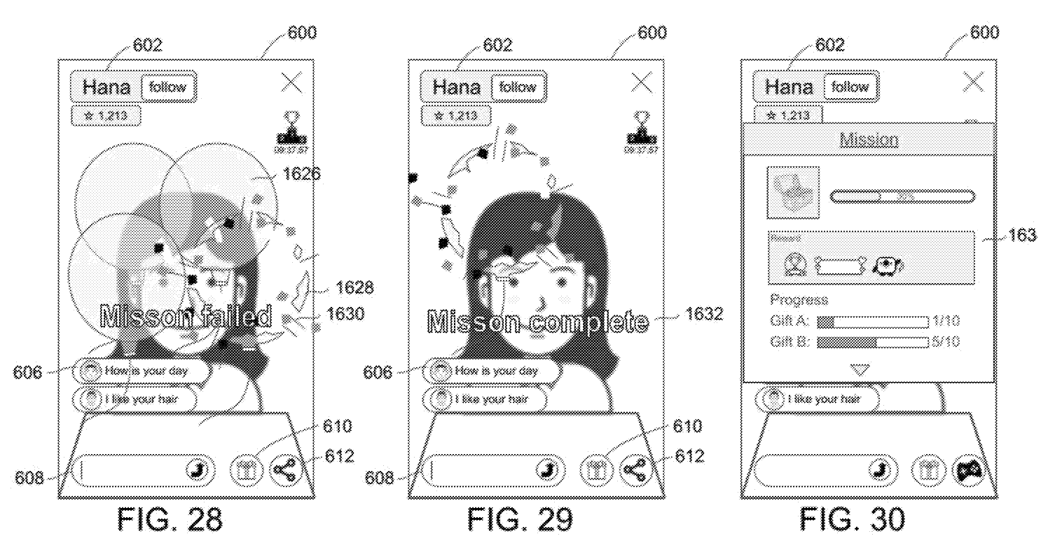

FIG. 25 - FIG. 30 are exemplary screen images of a live streaming room screen 600 shown on the display of the livestreamer user terminal 120 or the viewer user terminal 130.

In some embodiments, the streamers may meet the collaboration gift requirement according to the interaction in the live streaming room. In some embodiments, the requirement may be any possible parameters in or out of the live streaming room. Once the collaboration gift requirement is achieved, a mission may be triggered in the live streaming room. The viewers in the live streaming may collaborate and work together on sending gifts or collect specific gifts or the like.

As shown in FIG. 26, once a mission is triggered, Server 110 may display the mission to streamers. In some embodiments, the mission may be displayed according to a script based on a configured logic. In some embodiments, the mission may include an animation 1620. The animation 1620 may be a mission start-up animation to indicate the mission the streamer is going to participate in. In some embodiments, the mission may include a UI interface 1622 as shown in FIG. 26 for the streamer to determine whether to participate in the mission or not.

In some embodiments, only the streamers may see the animation 1620 and UI interface 1622. In some embodiments, the streamers may click the accept button or reject button in the UI interface 1622. In some embodiments, the streamers may click the accept button to start the mission. In some embodiments, the streamers may click the reject button to dismiss the mission. Once the streamers accept the special mission, a mission start animation the same as or similar to the animation 1620 may be displayed for streamers and viewers.

In some embodiments, the mission may be provided via an interactive game between viewers and streamers. In some embodiments, after the start animation of the mission, a filter 1624 may be displayed on the streamer as shown in FIG. 27. In some embodiments, the filter 1624 may be transparent, semi-transparent, not transparent, opaque or the like. In some embodiments, the filter 1624 may cover the full live streaming room or cover at least a portion of the streamer such as the face, body or the like. In some embodiments, the filter 1624 may be any possible image such as the bubbles, balloons, or the like. In some embodiments, the setting of the mission may be determined flexibly.

In some embodiments, the viewers may work individually or together to help the streamer remove the filter 1624. In some embodiments, the viewers may complete the mission to remove the filter 1624. In some embodiments, the filter 1624 may be removed at once in response to the mission being completed. In some embodiments, the filter 1624 may be removed gradually in response to the mission being partially completed. In other words, once the mission is triggered, the streamer may be invisible or partially invisible to the viewers who are viewing the live streaming, and the streamer may be visible or partially visible to the viewers once the mission is completed or partially completed.

In some embodiments, the filter 1624 may include a plurality of portions and each portion may be corresponding to a sub-mission in the main mission. For example, the mission may be the gift collection of ten gift A and ten gift B respectively. The gift collection of ten gift A and ten gift B may be corresponding to different portions on the filter 1624. Once the viewers completed a portion of the mission, the corresponding portion of the filter 1624 may disappear or become semi-transparent or the like.

As shown in FIG. 27 and FIG. 28, the filter 1624 may be a plurality of balloons and each of the balloons may be a portion 1626 of the filter 1624. Once the viewers completed the mission or a portion of the mission such as completing the collection of ten gift A, the corresponding portion 1628 may be semi-transparent, disappeared or popped as shown in FIG. 28 or FIG. 29. In some embodiments, each portion 1626 of the filter 1624 may be corresponding to a portion of the mission, a completion percentage of the mission or the like and may be determined and adjusted flexibly.

In some embodiments, the portion 1626 to be disappeared or the like may be default, random or determined by the users or the like. For example, the balloons to be popped may be on the face of the streamer by default, randomly popped or determined by the viewers or streamers via performing an operation on the screen 600 or the like. In some embodiments, the mechanism of the mission may be determined flexibly according to the practical need.

In some embodiments, the duration of the mission may be determined flexibly. In some embodiments, the duration of the mission may be a predetermined duration such as 10 minutes, 1 day, until the end of the event the streamer is participating in or the like. In some embodiments, the duration of the mission may be only in the current live streaming. In other words, the mission may be invalid if the streamer ends the live streaming or the like. In some embodiments, the duration of the mission may be set flexibly according to the practical need.

In some embodiments, once the filter 1624 is on the streamer, the mission in detail may be displayed for the viewers’ reference. For example, it may display the designated lucky bag, gifts, and designated number of gifts. In some embodiments, if the gifts need to be sent by a specific user, the name of the specific user may also be displayed. In some embodiments, users in the live streaming room may send the designated gift or designated lucky bag to collect the designated gifts to complete the mission.

In some embodiments, if the viewer does not complete the mission, a UI 1630 may be displayed to indicate the result such as the “mission failed” or the like as shown in FIG. 28. In some embodiments, if the viewer successfully completes the mission, a UI 1632 may be displayed to indicate the result such as the “mission complete” or the like as shown in FIG. 29. In some embodiments, if the mission is successfully completed, Server 110 may distribute the rewards to the users.

In some embodiments, the users eligible for rewards may be the users in the live streaming room or the users who contribute to the completion of the mission or the like and may be determined flexibly. In some embodiments, the rewards may be applied among the live streaming platform or only in the current live streaming room. In some embodiments, once the mission is completed, a marquee in the live streaming room or across different live streaming rooms may be displayed to announce the completion of the mission or the like. In some embodiments, the way for displaying the mission may be determined flexibly.

In some embodiments, once the mission is in progress, a mission-in-progress may be displayed on the screen 600 for the viewers to understand the current state of the mission. In some embodiments, the icon may provide the information 1634 of, for example, the designated lucky bag, designated gifts, designated number of gifts as shown in FIG. 30. In some embodiments, the information 1634 may include the progress of the mission, the reward for completing the mission as shown in FIG. 30, or any possible information related to the mission. In some embodiments, the description or summary of the mission may also be provided and the contents may be generated by manually key-in or automatic generation such as AI generation or the like. In some embodiments, the contents on the information 1634 may be determined flexibly according to the practical need.

In some embodiments, the gift in an event may include a normal gift, or random bag or the like. The normal gift may be sent to the livestreamer with a specific number of points, and the livestreamer may receive the specific number of points from the viewer. The random bag may be sent to the livestreamer with a specific number of points and the livestreamer may receive points with a possibility of it being higher, equal to, or lower than the specific points. For example, a random bag may be worth 1,000 points and it may have a possibility of generating one million points, ten thousand points, one thousand points, zero points or the like.

In some embodiments, the random bag may be a general gift or a gift to be used specifically for an event, PK or the like. In some embodiments, the mission requires a collection of at least a gift item. The gift item(s) may be a general gift item or a gift generated from the random bag. In some embodiments, the gift item(s) for achieving a mission may be sent from one or more than one viewer in the live streaming room.

In some embodiments, the condition for triggering a mission in the live streaming room may be any possible parameter in the live streaming room. For example, the mission may be triggered by the viewers sending a specific amount of gifts to the streamer or the like. In some embodiments, the mission may be triggered according to the expectation value of the random bag. More specifically, if the point generated from the random bag is lower than a threshold point, the mission may be triggered for the viewers to complete and earn some reward from the mission. For example, if the value of the random bag is 1,000 but the generated point from the random bag is lower than 100, a mission may be generated accordingly.

In some embodiments, Server 110 may receive a request from a viewer of a viewer user terminal to use a virtual gift item associated with a first point. In some embodiments, Server 110 may generate a second point based on the first point, and the generated second point is higher than, equal to, or lower than the first point. In some embodiments, Server 110 may display the generated second point to the streamer of the streamer user terminal in a live streaming room. In some embodiments, Server 110 may further update points of the viewer and the streamer based on the first point and generated second point. In some embodiments, a mission associated with the live streaming room may be triggered in response to the generated second point being lower than a threshold point.

In some embodiments, the threshold point may be the expectation value of the random bag. In some embodiments, the threshold point may be determined based on a ratio of a generated point over point to be used on the virtual gift item in the live streaming room. In some embodiments, the generated point and the point to be used on the virtual gift item may be calculated according to a specific user, a specific live streaming room or all over the live streaming platform.

In some embodiments, the expectation value of the random bag may be calculated according to a specific user, a specific live streaming room or all over the live streaming platform. In other words, the expectation value of the random bag may be calculated based on the specific viewer, the specific live streaming room or all live streaming rooms in the live streaming platform. Once the total or average expectation value of the random bag is lower than a predetermined threshold value, the mission may be triggered accordingly. In some embodiments, the predetermined threshold value may be determined or dynamically adjusted according to the practical need.

In some embodiments, the collection of the gift in a mission may be determined flexibly. In some embodiments, the collection of the gift in a mission may be determined based on the streamers’ conditions. For example, collection of the gift in a mission may be according to a random bag from the viewers to the streamers. If the viewers send the same random bags to the streamer, the random bag may be the virtual gift in the mission.

If the viewers send different random bags to the streamer and one of the random bags is the event gift from the event the streamer is participating in, the random bag associated with the event may be the virtual gift in the mission. If the viewers send different random bags and none of them are associated with an event or the streamer does not participate in an event, the random bag may be determined manually, randomly or according to predetermined system default or the like.

In some embodiments, the gift collection may be general gifts or gifts generated from the random bag. The viewers may send more random bags to collect the necessary gift item to achieve the mission. In some embodiments, the collected gifts in a mission may be any possible value of a general gift or gifts generated from the random bag. In some embodiments, only the gifts with a point equal to or lower than the random bag value may be selected to be the collected gift in a mission.

For example, a random bag with value of 1,000 and the generated gifts from the random bag may include gift A (10), gift B (100), gift C (1,000) and gift D (1 million). Once the random bag is selected as the random bag in a mission, the gift collection in the mission may be, for example, the gift A (10), gift B (100) and gift C (1,000). In some embodiments, the gift collection in a mission may be determined flexibly according to the practical need.

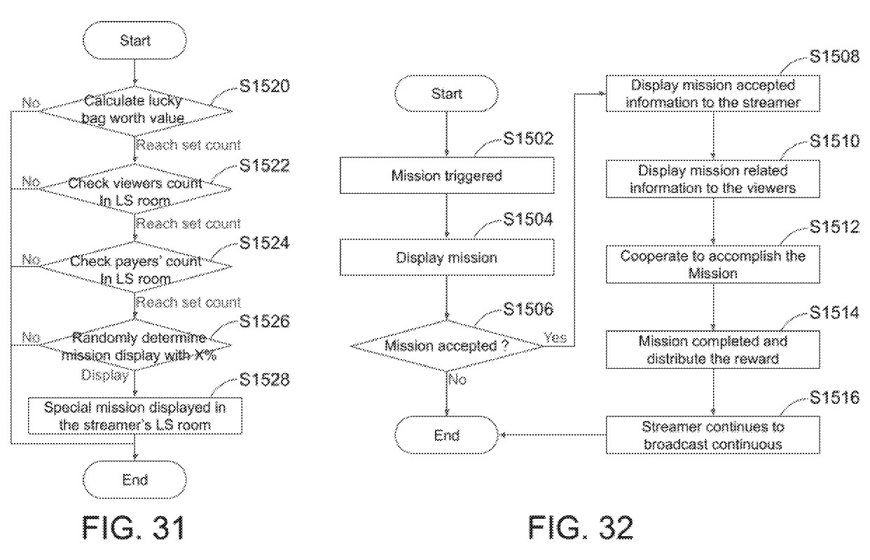

FIG. 31 is flowchart showing steps of the triggering of the mission in the live streaming room as an embodiment. In some embodiments, the random bag worthing value may be calculated to determine the triggering of the mission. More specifically, if the value generated from the random bag is lower than a specific threshold, then the mission may be triggered. The value may be the expectation value of the random bag sent by a specific viewer, all viewers in the live streaming room or among the live streaming platform or the like.

In some embodiments, if the random bag worthing value does not reach the set count (No in S1520), then the mission may not be triggered and the process ends. In some embodiments, if the random bag worthing value reaches the set count (reach set count in S1520), then the mission may be triggered or other requirements on triggering of the mission may be considered or the like.

In some embodiments, the viewers count may be checked to determine the triggering of the mission. More specifically, the number of the viewers in the live streaming room may be taken as a consideration to trigger the mission. For example, the mission may be triggered in the live streaming room with the number of viewers being over a threshold such as 1,000 or the like. In some embodiments, if the mission requires gifts from different viewers, the number of viewers in the live streaming room may be critical to determine the trigger of the mission or the like.

In some embodiments, if the viewers count does not reach the set count (No in S1522), then the mission may not be triggered and the process ends. In some embodiments, if the viewers count reaches the set count (reach set count in S1522), then the mission may be triggered or other requirements on triggering of the mission may be considered or the like.

In some embodiments, the payers’ count may be checked to determine the triggering of the mission. More specifically, the number of the payers in the live streaming room may be taken as a consideration to trigger the mission. Here, the payers may be referred to the viewers who contribute to the live streaming platform such as the one who topped up points in the live streaming platform, or the one who processes points, or the one who sent the gift to the streamers or the like. The number of the paid viewers in the live streaming room may be critical to determine the trigger of the mission or the like.

In some embodiments, if the payers’ count does not reach the set count (No in S1524), then the mission may not be triggered and the process ends. In some embodiments, if the payers’ count reaches the set count (reach set count in S1524), then the mission may be triggered or other requirements on triggering of the mission may be considered or the like.

In some embodiments, the mission may be triggered randomly or based on a specific percentage such as 10% or the like. For example, the mission may be triggered randomly so the users in the live streaming room may feel surprised to take the mission or the like. In some embodiments, if the mission is not triggered randomly (No in 526), then the mission may not be triggered and the process ends. In some embodiments, if the mission is triggered randomly (display in S1526), then the mission may be triggered accordingly (S1528). In some embodiments, other parameters in the live streaming may be determined to trigger the mission and the parameters may be determined flexibly according to the practical need.

FIG. 32 is flowchart showing steps of the mission in the live streaming room as an embodiment. In some embodiments, once the streamers successfully meet the requirement of collaboration gift, the mission may be triggered (S1502). The mission may be displayed on the user terminal of the streamer (S1504). In some embodiments, Server 110 may display a message to confirm whether the streamer would like to accept the mission (S1506). In some embodiments, if the streamer does not accept the mission (No in S1506), the process ends. In some embodiments, if the streamer accepts the mission (Yes in S1506), Server 110 may display the mission accepted information to the streamer (S1508). In some embodiments, the mission related information may further be displayed to the viewers in the live streaming room (S1510).

In some embodiments, the viewers and streamers may cooperate to accomplish the mission (S1512). In some embodiments, the way to accomplish the mission may be, for example, gifting, following, watching, voting, gaming to the streamers or the like. In some embodiments, a special stream room filter may be rendered on the screen 600, and the viewers must complete the mission to remove the filter. In some embodiments, once the users successfully complete the mission, the corresponding reward may be distributed accordingly and completion message may be displayed in the live streaming accordingly (S1514). Once the mission is completed, the filter may be removed and the Streamer may continue to go on broadcasting (S1516).

According to the embodiments, the optimization of collaborative gifting features may enhance the sense of achievement and strengthen the interaction between streamers and viewers in the live streaming room. Furthermore, gift-sending triggered by special conditions could make the gifting interaction more engaging and enjoyable for users, alleviating any feelings or dissatisfaction and enhancing the overall fun of sending gifts.

According to the embodiments, the interaction between viewers and streamers in the live streaming room may be optimized. Therefore, it could make the live streaming platform more fun and the user experience may be improved. According to the present disclosure, it may motivate the viewers to have more interaction with the livestreamer. Moreover, it may add more fun to the live streaming room, and also make the interaction in the live streaming room smoother. Therefore, the user experience may be improved.

The livestreamer LV may be a real person or an AI model. The streaming data of the livestreamer LV may be generated or rendered in Server 110 or via a user terminal 120 or the like. The communication among the livestreamer LV and viewer AU1, AU2 may be realized via the network NW. In some embodiments, the AI model may be trained internally or provided by a third-party service such as Google PaLM, ChatGPT or other LLM (large language model) or the like.

In some embodiments, the present disclosure may include the following embodiments:

11. A server including a circuitry, wherein the circuitry is configured to perform: receiving a request from a first user of a first user terminal to use a virtual gift item associated with a first point; generating a second point based on the first point, wherein the generated second point is higher than, equal to, or lower than the first point; displaying the generated second point to a second user of a second user terminal in a live streaming room; and updating points of the first user and the second user based on the first point and generated second point; wherein a mission associated with the live streaming room is triggered in response to the generated second point being lower than a threshold point.

12. The server according to embodiment 11, including: the threshold point is determined based on a ratio of a generated point over point to be used on the virtual gift item in the live streaming room.

13. The server according to embodiment 11, including: in response to the mission being triggered, making the second user invisible or partially invisible to the first user and other users who are viewing the live streaming; and in response to the mission being completed or partially completed, making the second user visible or partially visible to the first user and other users.

14. The server according to embodiment 11, including: displaying a filter on at least a portion of the second user in the live streaming room; and removing the filter or a portion thereof in response to the mission being completed or partially completed.

15. The server according to embodiment 11, including: distributing a reward to the first user and other users who are viewing the live streaming in response to the mission being completed.

16. The server according to embodiment 11, including: providing a UI interface of a progress of the mission; wherein the UI interface includes information about a collection of at least a first gift item generated from the virtual gift item by at least one viewer in the live streaming room.

17. The server according to embodiment 11, including: retrieving a first script according to the request in response to the mission being triggered from the request; and displaying a triggering action according to the first script; wherein the triggering action at least includes a display of an animation in the live streaming room.

18. The server according to embodiment 11, including: the mission is further triggered based on the total number of viewers or paid viewers in the live streaming room, or in a random manner.

19. A method, including: receiving a request from a first user of a first user terminal to use a virtual gift item associated with a first point; generating a second point based on the first point, wherein the generated second point is higher than, equal to, or lower than the first point; displaying the generated second point to a second user of a second user terminal in a live streaming room; and updating points of the first user and the second user based on the first point and generated second point; wherein a mission associated with the live streaming room is triggered in response to the generated second point being lower than a threshold point.

20. A computer program for causing a server to realize the functions of: receiving a request from a first user of a first user terminal to use a virtual gift item associated with a first point; generating a second point based on the first point, wherein the generated second point is higher than, equal to, or lower than the first point; displaying the generated second point to a second user of a second user terminal in a live streaming room; and updating points of the first user and the second user based on the first point and generated second point; wherein a mission associated with the live streaming room is triggered in response to the generated second point being lower than a threshold point.

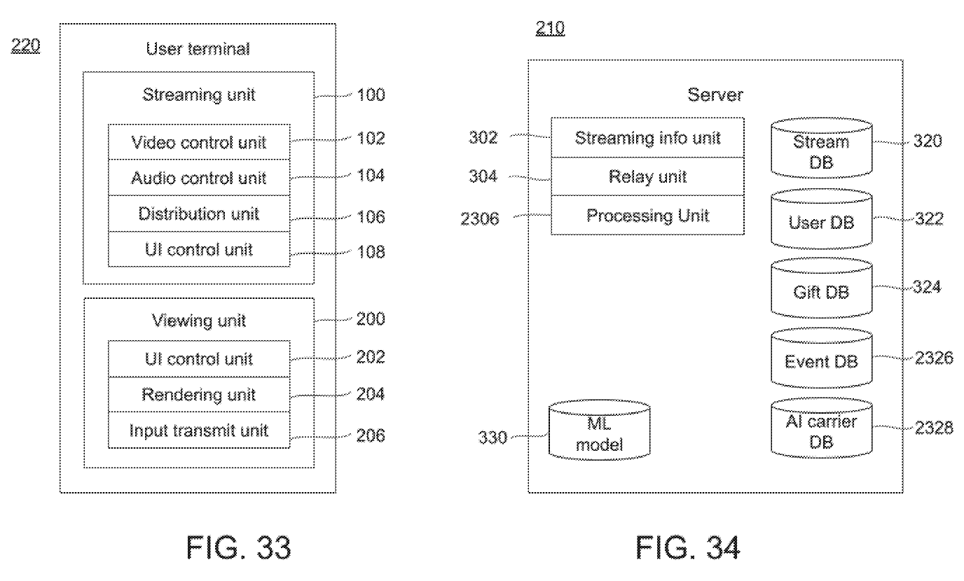

FIG. 33 is a block diagram showing a function and configuration of the user terminal 220 in FIG. 1 according to the embodiment of the present disclosure. FIG. 34 is a schematic block diagram of the Server 210 according to some embodiments of the subject application. The elements with the same element numbers may refer to that in FIG. 2 and FIG. 3, and are not described herein.

FIG. 34 is a schematic block diagram of the Server 210 according to some embodiments of the subject application. The Server 210 may include streaming info unit 302, relay unit 304, processing unit 2306, stream DB 320, user DB 322, gift DB 324, event DB 2326, AI carrier DB 2328 and ML model 330.

The processing unit 2306 is configured to perform the operations described in this disclosure. In some embodiments, the processing unit 2306 may execute a set of instructions stored in a memory module. In some embodiments, the processing unit 2306 may collect information such as the event data or the like from the event hub. Here, the hub or the event hub may be a concept in distributed systems and cloud architectures, and may refer to a system component used to centrally receive, process, and distribute events or messages. It acts as an intermediary or bridge for events. Once received an event, the Event Hub may forward these events to different destinations or the like.

For example, in a live streaming platform, there may be a plurality of events, which may be called campaigns, for the streamers or viewers to join in order to compete with each other and earn rewards or the like. The event data in the event hub may be called the event of event (campaign). In some embodiments, when a user sends a gift, the streamer’s ranking changes, or any changes during the event campaign, it may generate events. These events are sent to the Event Hub, which then decides whether to store them in a database, send them to an analytics service, or notify relevant units or the like.

In some embodiments, the processing unit 2306 may retrieve the corresponding event data dynamically from the event hub during the period of the event or the like. In some embodiments, the processing unit 2306 may identify, for example, the emotion, the status or the corresponding visual appearance or the like with respect to the status or the like. In some embodiments, the processing unit 2306 may feed the corresponding information into an AI carrier for the AI carrier to activate accordingly.

In some embodiments, the processing unit 2306 may be configured to perform one or more operations. In other embodiments, the processing unit 2306 may include one or multiple sub-units or modules, such as a data collection module, an analysis module, and a training engine or the like to realize the function. In some embodiments, the function may include collecting data, analyzing, generating, executing among others.

In some embodiments, the processing unit 2306 may retrieve event data associated with an event in which a first user of a first user terminal is participating in. In some embodiments, the processing unit 2306 may determine an emotional state and/or an appearance transformation corresponding to a progress state of the event. In some embodiments, the processing unit 2306 may generate a prompt command based on the emotional state and/or the appearance transformation. In some embodiments, the processing unit 2306 may transmit the prompt command to an AI carrier associated with the first user of the first user terminal. In some embodiments, the processing unit 2306 may updating the emotional state and/or the appearance transformation on the AI carrier according to the prompt command.

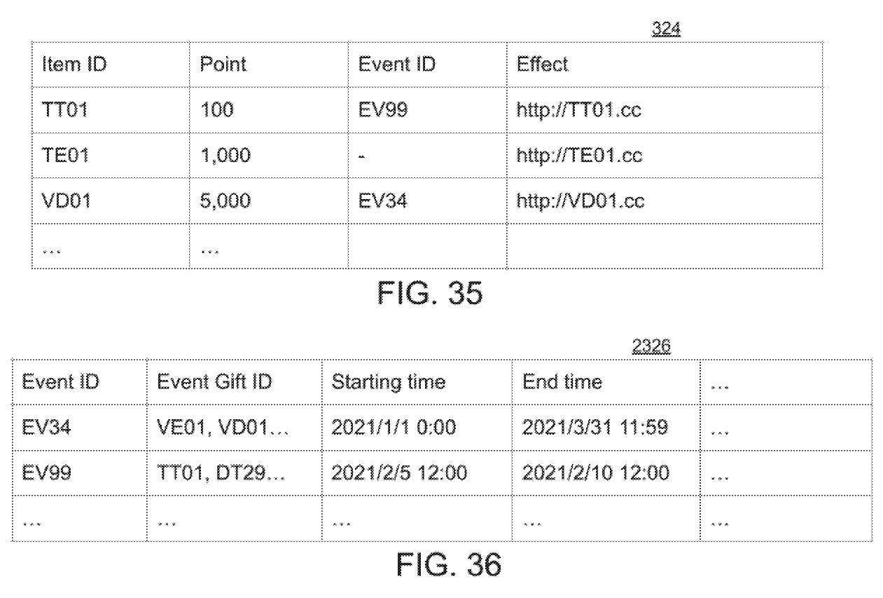

FIG. 35 shows an exemplary data structure of the gift DB 324 of FIG. 34, and may refer to the gift DB 324 in FIG. 6. FIG. 36 shows an exemplary data structure of the event DB 2326 of FIG. 34. The event DB 2326 holds information regarding events on a live distribution platform provided by the live streaming system 1. The event DB 2326 stores an event ID for identifying an event, title for identifying title of the event, tag for identifying category or topic of the events, the period for identifying the starting time and end time of the event, the gift ID for identifying the gift in an event, the event URL for identifying the location of the event page, in association with each other.

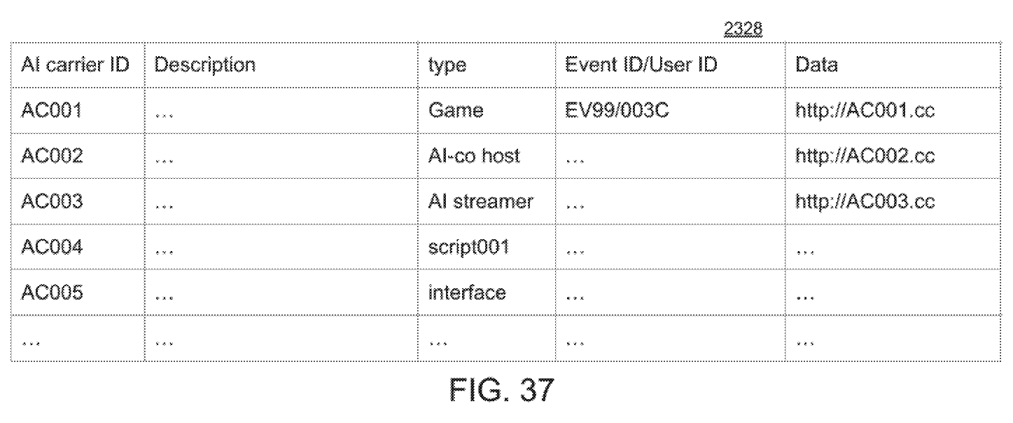

FIG. 37 shows an exemplary data structure of the AI carrier DB 2328 of FIG. 34. The AI carrier DB 2328 holds information regarding AI carriers in live streaming system 1. The AI carrier DB 2328 stores an AI carrier ID for identifying an AI carrier, description for identifying details of the AI carrier, type for identifying category or topic of the AI carrier, the event ID or user ID for identifying the event or the user involved in the AI carrier, the data for identifying the data information of the AI carrier, in association with each other.

In the live streaming platform, the platform providers always hold events to motivate the interaction between streamers and viewers. The streamers may select an event and start broadcasting. In order to win the events and receive reward, the streamers may do their best to cheer up the viewer. However, in some situations the viewers may not be motivated and even feel uncomfortable to support the streamers. Therefore, transferring the process of the event into another AI carrier may be an alternative to motivating the interaction.

In some embodiments, the event may be the campaign event held by the platform providers, or any possible event style such as a voting, a gaming, or competition organized in the live streaming platform or the like. Here, the campaign event in a live streaming platform is taken as an example to explain the disclosure. In some embodiments, the event may be any possible topic with a specific purpose, and the rule of the event may be determined flexibly. For example, the title of the event may be “Weight Loss Challenge”, and a virtual gift of “Slimming Class Enrollment” may be provided for the viewers to send and for the streamers to collect in order to win rewards.

In some embodiments, the emotional state and/or the appearance transformation may be associated with the topic of the event. For example, the emotional state may include positive or negative emotion and the appearance transformation may include being fat or thin on an appearance of the AI carrier according to the contents of the event. For another example, if the streamer is participating in an event related to the ancient Chinese palace life, the AI co-host of the streamer may be dressed in traditional imperial court clothing or the like. In some embodiments, the event may have different topics such as going to school, for seasons or famous IP such as Ghibli or Doraemon, and the AI carrier may change the emotion or appearance according to the contents of the event or the like.

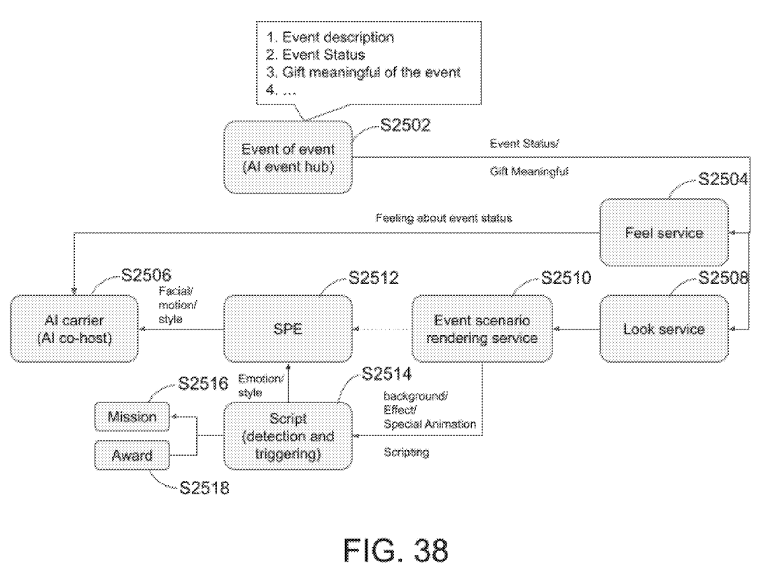

FIG. 38 is exemplary functional configuration of the live streaming system 1 according to some embodiments of subject application. The event data, which may refer to the event of event, may be collected and exchanged in the AI event hub (S2502). In some embodiments, the event data may be, for example, the event description, the event status such as the ranking or the like, the meaning of each gift such as the event gift or the possible data relating to the event. In some embodiments, the processing unit 2306 may retrieve the event data and transfer them into another AI carrier or the like. In some embodiments, the transferring may be optional, which means that the streamers or the viewers may determine to transfer or not.

In some embodiments, the processing unit 2306 may analyze and identify the feel and look from the event data via the feel service (S2504) and look service (S2508). In some embodiments, the feel may refer to the soul of the AI carrier and the look may refer to the appearance of the AI carrier. In other words, the feel may be the inner emotion or atmosphere and the look may be the outer appearance of the AI carrier. In some embodiments, the analysis and identification of the feel and look may be realized via an internal service, pre-train machine learning model, or a third-party service or machine learning technology or the like.

In some embodiments, the communication may be realized via the prompt, which is the input text given to a model to trigger it to generate a response that meets the intended requirement. For example, if the streamer falls out of top 10 in the event of “Weight Loss Challenge”, a prompt of “you become fat so feel unhappy to talk to the viewers” may be fed into the AI carrier since gaining or losing weight affects emotion and emotion affects the interaction style or the like. Furthermore, an appearance of the AI carrier being fat may be generated and rendered on the AI carrier via the prompt of “generating an appearance of being fat” or the like. In some embodiments, the details of the realization may be determined flexibly.

In some embodiments, the AI carrier may be any possible object with an AI model embedded in the live streaming room. More specifically, the AI carrier refers to a virtual object embedded with an AI model in a live streaming room or a physical object installed with the AI model being visible in the live streaming room or in proximity to the streamer or the like. For example, the AI carrier may be an AI co-host, an AI virtual streamer, a game interaction, the overall interface in the live streaming room such as an icon, a background, a decoration, a canvas, a comment, the font, color or the like of the text or a script in the live streaming room. In some embodiments, the AI carrier may be a physical object such as a wearable device, or a device such as a fan or the like nearby the streamer or the like. Here, the script may refer to a combination of a triggering event and triggering action in the live streaming room.

For example, if the viewer sends the combo gift over 10 times, then a special effect animation is triggered in the live streaming room. The triggering event may be the “combo gift over 10 times” and the triggering action may be “displaying special effect animation”. In some embodiments, the script may be stored in a database such as the script DB (not shown), and be detected and triggered dynamically. Here, the AI co-host is taken as an example to explain the disclosure.

As shown in FIG. 38, the feel service (S2504) may generate a prompt of “you become fat so feel unhappy to talk to the viewers” and feed into the AI carrier (S2506), which is the AI co-host of the streamer. Therefore, the AI co-host may respond to the viewers with the unhappy emotion, so the viewers may understand that the streamer is falling behind in the event. According to the embodiments, it provides an alternative to motivate the viewers to help and support the streamers and the interaction may be improved.

Furthermore, the look service (S2508) may generate a prompt of “generating an appearance of being fat” and provide it to the event scenario rendering service (S2510). In some embodiments, the event scenario rendering service (S2510) is configured to handle the generation and the rendering of the appearance. In some embodiments, the prompt may affect various aspects of the AI co-host, including its personality traits, tone of voice, emotional state, speaking mannerisms, and even visual appearance (e.g., progressively gaining weight).

Once the event status is detected and the prompt of “generating an appearance of being fat” is generated, the event scenario rendering service (S2510) may further, for example, generate an image or a series of motion pictures according to the prompt. In some embodiments, the generation and rendering may be realized via the AI machine learning model or third-party service such as Live2D or the like.

In some embodiments, the SPE service (S2512) may further determine the details for rendering or displaying on the AI co-host (S2506). In some embodiments, the SPE service (S2512) may determine the timing, duration of the image or the motion of the AI co-host. For example, once the streamer falls behind and falls out of top 10 in the event of “Weight Loss Challenge”, the generated fat appearance may be rendered on the AI co-host for 5 seconds or until the end of the event or the like. In some embodiments, the details of the SPE service (S2512) may be determined flexibly.

In some embodiments, the event scenario rendering service (S2510) may determine the detection and triggering of the script (S2514) in the live streaming room or the like. In some embodiments, the event scenario rendering service (S2510) may trigger the SPE service (S2512) directly or indirectly via the script (S2514). As stated above, the script may be the combination of the triggering event and triggering action in the live streaming room. In some embodiments, the mission in a live streaming room may be a triggering action, which is to trigger a mission (S2516) for the streamers and viewers to achieve.

In some embodiments, the event scenario rendering service (S2510) may trigger the SPE service (S2512) directly as the dot arrow in FIG. 38. In some embodiments, the event scenario rendering service (S2510) may trigger the SPE service (S2512) indirectly via the script (S2514). One advantage of this embodiment is that the appearance and/or the emotion on the AI carrier to be displayed on the terminal side may all be handled and controlled by a script. The client-side terminal may execute the related animation or display on the terminal according to a script in the terminal side. According to the embodiments, it allows for easier expansion of triggering events and trigger actions, and also simplifies the animation display on the client side.

Once the mission (S2516) is achieved, the award (S2518) may be distributed to the streamers and viewers. For example, if the point generated from the random bags is lower than a threshold point, a mission may be triggered for the viewers to complete and earn some award to compensate for the loss from the random bags. In some embodiments, the mission associated with the live streaming room may be triggered in response to a gifting situation satisfying a specific condition. For example, if the gifting situation does not achieve a specific value or the expectation value of the random bag or the lucky bag does not achieve a threshold or the like. In some embodiments, the setting and of the mission (S2516) and award (S2518) may be determined flexibly.

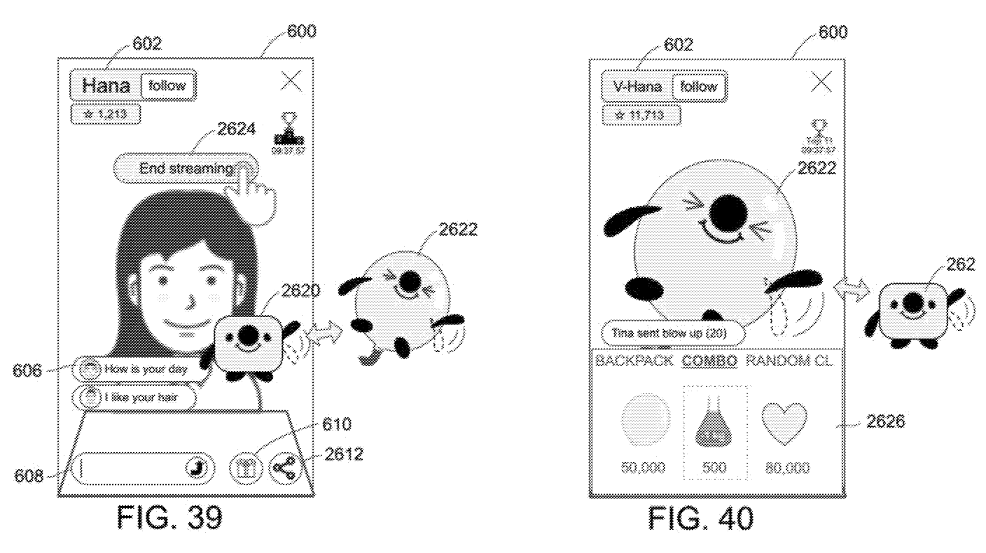

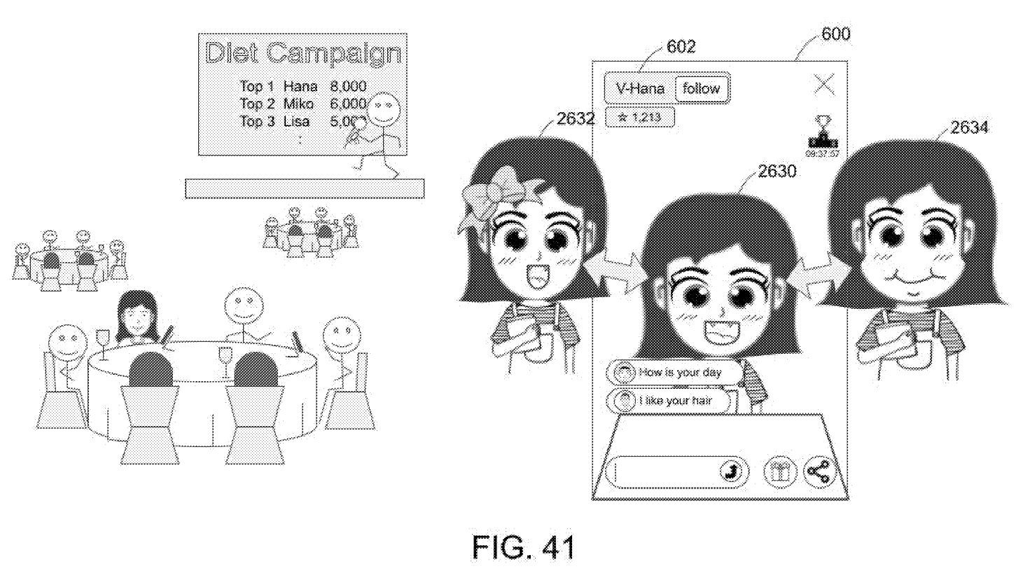

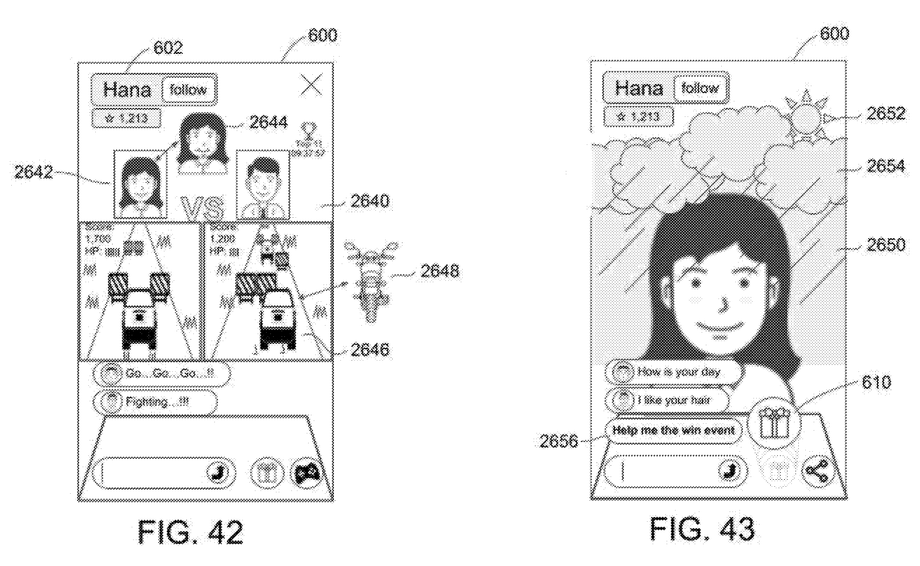

FIG. 39 - FIG. 43 are exemplary screen images of a live-streaming room screen 600 shown on the display of the livestreamer user terminal 220 or the viewer user terminal 230. In some embodiments, the live streaming room screen 600 may include an AI co-host 2620 as shown in FIG. 39. The AI co-host may be referred to as an AI carrier in the format of AI assistance with AI machine learning models attached. In some embodiments, the AI co-host 2620 may assist the streamer in enhancing viewer engagement and interaction. In some embodiments, the AI co-host 2620 may facilitate live interaction. For example, the AI co-host 2620 may analyze the chat content, viewer interaction history, and the overall atmosphere of the live room to proactively engage with viewers and help the streamer maintain a lively environment.

In some embodiments, the AI co-host 2620 may recommend discussion topics based on ongoing chat content, current trends or the like, and the recommended topics may further be pinned as topic stickers on the screen 600 to encourage viewers to join the discussion. In some embodiments, the AI co-host 2620 may support feedback-based topic adjustment. In some embodiments, the AI co-host 2620 may automatically interact with viewers on behalf of the streamer, enabling the streamer to focus more on content delivery. In some embodiments, the function of the AI co-host 2620 may be designed flexibly.

In some embodiments, the event data may be fed into the AI co-host 2620. In some embodiments, the event data may be in real-time or historical. In some embodiments, the status of the event data may be used to determine the feel and look of the AI co-host 2620. In some embodiments, the feel and look of the AI co-host 2620 may be, for example, the emotion and appearance of the AI co-host 2620. In some embodiments, the relationship between the status of the event data and the feel and look of the AI co-host 2620 may be determined via pre-set rules or inferred via a machine learning model or the like.

In some embodiments, if the event the streamer is participating in is related to a Big Eater and the virtual gifts may be a series of high-calorie food such as fried chicken, cake or the like. As shown in FIG. 39, if the streamer received a lot of virtual gifts during the event, the AI co-host 2620 may become fatter and fatter as a fatty AI co-host 2622. According to the embodiments, the streamer and viewers may understand the status of the event via watching the change of the AI co-host 2620.

In the past, if the streamers would like to have the support from the viewers, they always have to tell the viewers, for example, the current ranking and the points they need to surpass the first place. Based on this disclosure, the streamers may, for example, tell the viewers that my AI co-host 2620 is hungry or too thin, please help me to feed the AI co-host 2620 or the like. According to the embodiments, the interaction between the streamers and viewers may be more interesting and user centric.

In some embodiments, once the status of the event achieves a specific threshold or the like, the emotion or the appearance of the AI co-host 2620 may change accordingly. For example, if the streamer earns 1 million points or ranks in the top three, the AI co-host 2620 may get fat like a sumo wrestler or sing we are the Champions or the like. In some embodiments, the streamer may say, for example, I think the AI co-host 2620 would look better if gaining more weight to motivate the viewer to send the virtual gift. According to the embodiments, the interactions would become more diverse.

In some embodiments, the AI co-host 2620 and AI co-host 2622 may be an image generated via software or AI, and rendered on the screen 600 to display. In some embodiments, the generation of the appearance of the AI co-host 2622 may be a series of images such as the AI co-host 2620 being fat or thin gradually or the like. In some embodiments, the face features and body movement of the AI co-host 2622 such as the eyes, mouth, hands or the like may change accordingly. In some embodiments, the generation and rendering of the AI co-host 2620 may be realized via an internal or third-party software or machine learning model such as the Live2D or the like.

In some embodiments, the AI carrier such as the AI co-host 2620 may be a 24-7 service in the live streaming room. For example, the AI carrier may keep broadcasting to interact with viewers after the streamer ends the live streaming. As shown in FIG. 39, the streamer may click a button 2624 to end the live streaming. Once the live streaming is ended, the AI co-host 2620 may disappear. In some embodiments, the AI co-host 2620 may be reset in the next live streaming or the like. In some embodiments, the setting or change of the AI co-host 2620 may be stored and kept in the next live streaming or the like. In some embodiments, even if the live streaming is ended, the AI co-host 2620 may automatically interact with viewers in the live streaming room or a separated live streaming room or the like as shown in FIG. 40.

In some embodiments, the viewers may keep interacting with the AI co-host 2620 and 622 after the live streaming provided by the streamer is over as shown in FIG. 40. In some embodiments, the viewers may keep sending virtual gifts to the AI co-host 2620, and the virtual gifts may be referred to as the offline gifts 2626 sent to the streamers. In some embodiments, the virtual gifts may include items which may change the emotion or appearance of the AI co-host 2620. For example, the gifts 2626 may include balloon air or weight loss liquid to make the AI co-host 2620 become fatter or thinner.

In some embodiments, if the viewers could not make it to the streamer’s live streaming, they may join the AI co-host 2620’s live streaming to catch up the status of the event. In some embodiments, if the viewers find that the streamer loses the event, the viewers may further help the streamer via sending virtual gifts to the AI co-host 2620. According to the embodiments, it may motivate the viewers to send the offline gifts, the AI co-host 2620 may interact with the viewers on behalf of the streamers and the AI co-host 2620 may help the streamer to receive the support from the viewers while the streamer is offline.

In some embodiments, the disclosure may also be applied in an offline event. FIG. 41 shows an example of the offline event. In the offline event, there may be a lot of tables and chairs for the streamers to sit on and have a broadcast to urge their viewers to support them to win the offline event. There may be a host on the stage to introduce the event and control the flow of the event. The status of the event may include possible triggering points such as receiving points being over a threshold, being top 10 in a final leaderboard or the like. The AI carrier may be an AI virtual character 2630 of the streamer or any possible digital avatar or the like.

As shown in FIG. 41, the appearance of the AI virtual character 2630 may change according to the status of the offline event. For example, the AI virtual character 2630 may become a thin character 2632 with a ribbon, or a fat character 2634 with a chubby face or the like. In some embodiments, the special effect of the appearance may be rendered on the AI virtual character 2630 or the streamers themselves. In some embodiments, the duration of the special effect may be a specific period of time or during the period of the event or the like. In some embodiments, the setting of the special effect may be determined flexibly.

In some embodiments, the AI event hub may be the event hub of the campaign event, which is the event of the event. In some embodiments, the AI event hub may be the event hub for others in the live streaming room. For example, the AI event hub may be the event hub of game interaction, voting, or multi-user interaction such as PK or group call or any possible scenario in the live streaming room.

FIG. 42 shows an example of the multi-user interaction of PK at a game interaction scenario. In some embodiments, the streamer may have a PK with other streamers, and the PK may be a competition of receiving points from the viewers or a game competition 2640 as shown in FIG. 42. In some embodiments, the AI event hub may handle the game interaction data and the game interaction data may be fed into a machine learning model to generate, for example, the emotion or the appearance or the like.

In some embodiments, the AI carrier may be, for example, the image or streaming data of the streamers 2642 or the like. In some embodiments, if the streamer 2642 leads or has fallen behind during the game interaction, the appearance of the streamer 2642 may change to, for example, a chubby streamer 2644 or the like. In some embodiments, if the streamer 2642 receives less points or loses the PK, the appearance of the streamer 2642 may change to, for example, a chubby streamer 2644 or the like. In some embodiments, the setting of the AI event hub may be determined flexibly according to the practical need.

In some embodiments, the AI carrier may be any possible object with an AI model in the live streaming room. In some embodiments, the AI carrier may also be a game interaction as shown in FIG. 42. In some embodiments, the streamer may play a game on the screen 600 in the live streaming room. In some embodiments, the users may have a single-player or multiple-players game with the other livestreamers, viewers, computer players, AI players or the like.

In some embodiments, if the streamers participate in an event or a PK competition, the game interaction may be determined according to the event status or PK status. For example, if the streamer is falling behind during an event, the vehicle of the streamer in the game may be changed from automobile 2646 to motorcycle 2648 or the like. In some embodiments, the object to be changed in the game may be any possible object in the game such as the vehicle, the user avatar, the background, the monster, the health points or the like. In some embodiments, the setting of the function may be determined flexibly.

In some embodiments, the AI carrier may be the overall interface in the live streaming room. FIG. 43 shows an example of the overall interface in the live streaming room. As shown in FIG. 39, the live streaming room screen 600 may include a livestreamer info object 602, livestreamer image 604, message zone 606, message input box 608, gift object 610, sharing object 2612 or the like. In some embodiments, if the streamer is falling behind in an event and the feel of the streamer, which may be the emotion of the streamer, is negative, a background 2650 of darker tones may be displayed on the screen 600 to indicate the event status or the like.

In some embodiments, the emotion or the appearance according to the event status may be displayed via some UI object in the live streaming room. For example, if the emotion is positive or negative, the UI object of a sun 2652 or rainy cloud 2654 may be generated and rendered to display the event status or the like. In some embodiments, the emotion or the appearance may be displayed on the comment, message, text or the like. For example, if the appearance is being fat or thin, the font size, weight, and color of the message 2656 may change accordingly.

In some embodiments, the emotion or the appearance may be displayed in any possible UI object such as the button, sticker or the like on the screen 600 in the live streaming room. For example, if the streamer is falling behind in the event, the appearance of the gift object 610 may become bigger and bigger. According to the embodiments, the viewers may understand that the streamer is falling behind and need their support via sending gifts to help the streamer.

In some embodiments, the AI carrier may be any possible virtual object in the live streaming room or live streaming platform. In some embodiments, the AI carrier may be a real physical item with AI installed or the like. In some embodiments, the items may be objects videotaped in the live streaming data or the objects around the streamer or the like. For example, the item may be a wearable device such as the watch, earrings, necklace, patches or a device nearby the livestreamer such as a scent diffuser, music box, electric fan, dolls, chairs, desks, glass cup, drone, robot, party ball or the like.

In some embodiments, the AI event hub and AI carrier may be determined flexibly according to the practical need. For example, if the streamer is participating in a retro party event, the AI co-host may be dressed in retro clothing or performing a simple disco dance or the like. In some embodiments, the communication between the AI event hub and AI carrier may be realized via the prompt communication. According to the embodiments, the generation and rendering of the AI co-host may determine according to the status of the event, and it may make the display of the live streaming room more interactive and the user experience may be improved.

The livestreamer LV may be a real person or an AI model. The streaming data of the livestreamer LV may be generated or rendered in Server 210 or via a user terminal 220 or the like. The communication among the livestreamer LV and viewer AU1, AU2 may be realized via the network NW. In some embodiments, the AI model may be trained internally or provided by a third-party service such as Google PaLM, ChatGPT or other LLM (large language model) or the like.

In some embodiments, the appearance transformation may include extracting a portion of the AI carrier. In some embodiments, the extracted portion may be performed with image editing and being rendered on the AI carrier. In some embodiments, the extracted portion may be corresponding to a facial portion or body portion of the AI carrier. In some embodiments, the edited portion includes a difference with respect to the first portion in size, age, expression or movement.

In some embodiments, the ML model 330 or a separated ML model (not shown) may monitor the generation of the ML model 330. In some embodiments, if the generation from the ML model is not consistent with the status of the event, another generation in response to the inconsistency from the ML model may further be triggered dynamically and be added on the AI carrier. For example, if the appearance should be getting thin but the fat appearance is generated, a further emotional prompt such as “I am getting wrong on the appearance” may further be generated and added on the AI carrier.

In some embodiments, the inconsistency may include any possible conditions such as the contents opposite or irreverent to the expected contents, the factually incorrect, or contrary to common understanding. For example, if a three-eyed or four-legged person is generated, the ML model may dynamically check and respond to the inconsistency. In some embodiments, the response may be a replacement of the inconsistency one, a supplemental emotion or appearance based on the inconsistency or an explanation on the inconsistency due to the technical or unknown issue or the like. According to the embodiments, the quality of the generation from the ML model may be guaranteed and improved and the user experience may be improved.

According to the present disclosure, it may improve the usage of the AI model in the live streaming room. Moreover, another way to enhance the interaction and motivate viewers to support the streamers is also provided. Therefore, the livestreamers and viewers may feel interested and satisfied, instead of feeling anxious, and the user experience may be enhanced. Therefore, the user experience may be improved.

In some embodiments, the present disclosure may include the following embodiments:

21. A method, including: retrieving event data associated with an event in which a first user of a first user terminal is participating in; determining an emotional state and/or an appearance transformation corresponding to a progress state of the event; generating a prompt command based on the emotional state and/or the appearance transformation; transmitting the prompt command to an AI carrier associated with the first user of the first user terminal; and updating the emotional state and/or the appearance transformation on the AI carrier according to the prompt command.

22. The method according to embodiment 21, wherein: the AI carrier refers to a virtual object embedded with an AI model in a live streaming room or a physical object installed with the AI model being visible in the live streaming room or in proximity to the first user.

23. The method according to embodiment 21, wherein: the AI carrier keeps broadcasting to interact with viewers while the first user of the first user terminal is offline; the points sent by the viewers to the AI carrier are transferred to the first user of the first user terminal.

24. The method according to embodiment 21, wherein: the event including a topic indicating a purpose of the event; wherein the emotional state and/or the appearance transformation is associated with the topic of the event.

25. The method according to embodiment 21, wherein: updating on the AI carrier further includes updating an overall interface in a live streaming room; and the overall interface in the live streaming room includes the background, decoration, or display of the message in the live streaming room.

26. The method according to embodiment 21, including: monitoring the generation of the emotional state and/or the appearance transformation; upon detecting an inconsistency in the generation during monitoring, triggering a second generation based on the detected inconsistency; and dynamically updating the second generation on the AI carrier.

27. The method according to embodiment 21, including: a mission associated with the live streaming room is triggered in response to a gifting situation satisfying a specific condition; distributing a reward to the first user and other users who are viewing the live streaming in response to the mission being completed.

28. The method according to embodiment 21,: The appearance transformation includes an extracting a portion of the AI carrier, performing image editing and rendering the edited portion on the AI carrier; the portion is corresponding to a facial portion or body portion of the AI carrier; and the edited portion includes a difference with respect to the first portion in size, age, expression or movement.

29. A server including a circuitry, wherein the circuitry is configured to perform: retrieving event data associated with an event in which a first user of a first user terminal is participating in; determining an emotional state and/or an appearance transformation corresponding to a progress state of the event; generating a prompt command based on the emotional state and/or the appearance transformation; transmitting the prompt command to an AI carrier associated with the first user of the first user terminal; and updating the emotional state and/or the appearance transformation on the AI carrier according to the prompt command.

30. A computer program for causing a server to realize the functions of: retrieving event data associated with an event in which a first user of a first user terminal is participating in; determining an emotional state and/or an appearance transformation corresponding to a progress state of the event; generating a prompt command based on the emotional state and/or the appearance transformation; transmitting the prompt command to an AI carrier associated with the first user of the first user terminal; and updating the emotional state and/or the appearance transformation on the AI carrier according to the prompt command.

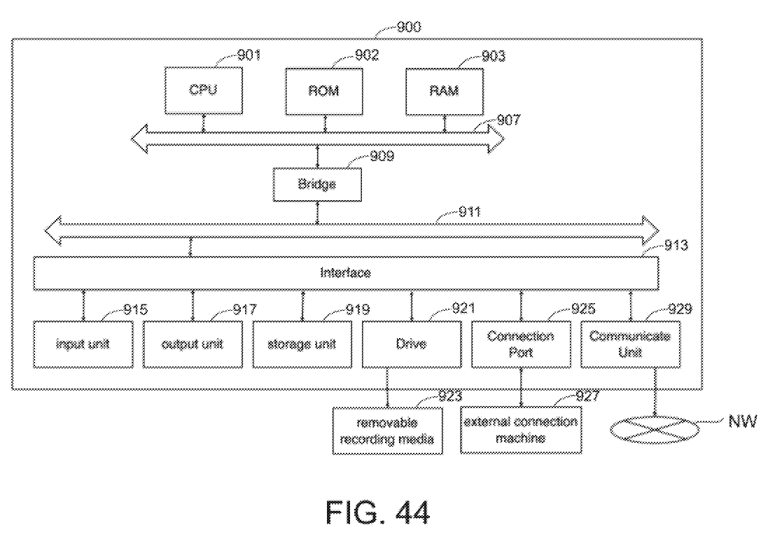

FIG. 44 is a schematic block diagram of computer hardware for carrying out a system configuration and processing according to some embodiments of subject application. The information processing device 900 in FIG. 44 is, for example, is configured to realize the server 10 and the user terminal 20, 30 respectively according to some embodiments of subject application.

The information processing device 900 includes a CPU 901, read only memory (ROM) 902, and random-access memory (RAM) 903. In addition, the information processing device 900 may include a host bus 907, a bridge 909, an external bus 911, an interface 913, an input unit 915, an output unit 917, a storage unit 919, a drive 921, a connection port 925, and a communication unit 929. The information processing device 900 may include imaging devices (not shown) such as cameras or the like. The CPU 901 is an example of hardware configuration to realize various functions performed by the components described herein. The functions described herein may be realized by circuitry programmed to realize such functions described herein. The circuitry programmed to realize such functions described herein includes a central processing unit (CPU), a digital signal processor (DSP), a general-use processor, a dedicated processor, an integrated circuit, application specific integrated circuits (ASICs) and/or combinations thereof. Various units described herein as being configured to realize specific functions, including but not limited to the streaming unit 100, the viewing unit 200, the video control unit 102, the audio control unit 104, the distribution unit 106, the UI control unit 108, the UI control unit 202, the rendering unit 204, the input transmit unit 206, the streaming info unit 302, the relay unit 304, the processing unit 306, the stream DB 320, the user DB 322, gift DB 324, event DB 326, context DB 328, ML model 330, the processing unit 1210, the processing unit 1306, progress unit 1308, the mission DB 1326, the script DB 1214, 1328, the processing unit 2306, the event DB 2326, the AI carrier DB 2328 and so on, may be embodied as circuitry programmed to realize such functions.

The CPU 901 functions as an arithmetic processing device and a control device, and controls the overall operation or a part of the operation of the information processing device 900 according to various programs recorded in the ROM 902, the RAM 903, the storage unit 919, or a removable recording medium 923. For example, the CPU 901 controls overall operations of respective function units included in the server 10 and the user terminal 20 and 30 of the above-described embodiment. The ROM 902 stores programs, operation parameters, and the like used by the CPU 901. The RAM 903 transiently stores programs used when the CPU 901 is executed, and parameters that change as appropriate when executing such programs. The CPU 901, the ROM 902, and the RAM 903 are connected with each other via the host bus 907 configured from an internal bus such as a CPU bus or the like. The host bus 907 is connected to the external bus 911 such as a Peripheral Component Interconnect/Interface (PCI) bus via the bridge 909.

The input unit 915 is a device operated by a user such as a mouse, a keyboard, a touchscreen, a button, a switch, and a lever. The input unit 915 may be a device that converts physical quantity to electrical signal such as audio sensor (such as microphone or the like), acceleration sensor, tilt sensor, infrared radiation sensor, depth sensor, temperature sensor, humidity sensor or the like. The input unit 915 may be a remote-control device that uses, for example, infrared radiation and another type of radio waves. Alternatively, the input unit 915 may be an external connection device 927 such as a mobile phone that corresponds to an operation of the information processing device 900. The input unit 915 includes an input control circuit that generates input signals on the basis of information which is input by a user to output the generated input signals to the CPU 901. The user inputs various types of data and indicates a processing operation to the information processing device 900 by operating the input unit 915.

The output unit 917 includes a device that can visually or audibly report acquired information to a user. The output unit 917 may be, for example, a display device such as an LCD, a PDP, and an OLED, an audio output device such as a speaker and a headphone, and a printer. The output unit 917 outputs a result obtained through a process performed by the information processing device 900, in the form of text or video such as an image, or sounds such as audio sounds.

The storage unit 919 is a device for data storage that is an example of a storage unit of the information processing device 900. The storage unit 919 includes, for example, a magnetic storage device such as a hard disk drive (HDD), a semiconductor storage device, an optical storage device, or a magneto-optical storage device. The storage unit 919 stores therein the programs and various data executed by the CPU 901, and various data acquired from an outside.

The drive 921 is a reader/writer for the removable recording medium 923 such as a magnetic disk, an optical disc, a magneto-optical disk, and a semiconductor memory, and built in or externally attached to the information processing device 900. The drive 921 reads out information recorded on the mounted removable recording medium 923, and outputs the information to the RAM 903. The drive 921 writes the record into the mounted removable recording medium 923.

The connection port 925 is a port used to directly connect devices to the information processing device 900. The connection port 925 may be a Universal Serial Bus (USB) port, an IEEE1394 port, or a Small Computer System Interface (SCSI) port, for example. The connection port 925 may also be an RS-232C port, an optical audio terminal, a High-Definition Multimedia Interface (HDMI (registered trademark)) port, and so on. The connection of the external connection device 927 to the connection port 925 makes it possible to exchange various kinds of data between the information processing device 900 and the external connection device 927.

The communication unit 929 is a communication interface including, for example, a communication device for connection to a communication network NW. The communication unit 929 may be, for example, a wired or wireless local area network (LAN), Bluetooth (registered trademark), or a communication card for a wireless USB (WUSB).

The communication unit 929 may also be, for example, a router for optical communication, a router for asymmetric digital subscriber line (ADSL), or a modem for various types of communication. For example, the communication unit 929 transmits and receives signals on the Internet or transmits signals to and receives signals from another communication device by using a predetermined protocol such as TCP/IP. The communication network NW to which the communication unit 929 connects is a network established through wired or wireless connection. The communication network NW is, for example, the Internet, a home LAN, infrared communication, radio wave communication, or satellite communication.

The imaging device (not shown) is a device that images real space using an imaging device such as a charge coupled device (CCD) or a complementary metal oxide semiconductor (CMOS), for example, and various members such as a lens for controlling image formation of a subject image on the imaging device and generates a captured image. The imaging device may capture a still picture or may capture a movie.

The present disclosure of the live streaming system 1 has been described with reference to embodiments. The above-described embodiments have been described merely for illustrative purposes. Rather, it can be readily conceived by those skilled in the art that various modifications may be made in making various combinations of the above-described components or processes of the embodiments, which are also encompassed in the technical scope of the present disclosure.

The procedures described herein, particularly flowchart or those described with a flowchart, are susceptible of omission of part of the steps constituting the procedure, adding steps not explicitly included in the steps constituting the procedure, and/or reordering the steps. The procedure subjected to such omission, addition, or reordering is also included in the scope of the present disclosure unless diverged from the purport of the present disclosure.

In some embodiments, at least a part of the functions performed by the server 10 may be performed by other than the server 10, for example, being performed by the user terminal 20 or 30. In some embodiments, at least a part of the functions performed by the user terminal 20 or 30 may be performed by other than the user terminal 20 or 30, for example, being performed by the server 10. In some embodiments, the rendering of the frame image may be performed by the user terminal of the viewer, the server, the user terminal of the livestreamer or the like.

Furthermore, the system and method described in the above embodiments may be provided with a computer-readable non-transitory storage device such as a solid-state memory device, an optical disk storage device, or a magnetic disk storage device, or a computer program product or the like. Alternatively, the programs may be downloaded from a server via the Internet.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed but includes another variation and modification that do not disobey the present disclosure, and is the scope covered by the following patent application scope.

What is claimed is:

1. A server comprising a circuitry, wherein the circuitry is configured to perform:
detecting a first triggering point in a live streaming room;
extracting a first portion of a streamer from a streaming data provided by the streamer in response to the first triggering point in the live streaming room being detected;
performing processing of image editing with respect to the first portion; and
rendering the edited first portion on the streaming data.

2. The server according to claim 1, wherein:
the triggering point is corresponding to an event the streamer is participating in; and
the triggering point includes a beginning of the event, an ending of the event, a specific time period right before the ending of the event or a ranking change of the streamer in a leaderboard from the event.

3. The server according to claim 1, wherein:
the triggering point is corresponding to a receiving point of the streamer from an interaction with viewers in the live streaming room; and
the triggering point includes the receiving point being achieved a whole number ending in zeros or achieved a threshold value determined by the streamer.

4. The server according to claim 1, wherein:
the first portion is corresponding to a facial portion or body portion of the streamer; and
the edited first portion includes a difference with respect to the first portion in size, age, expression or movement.

5. The server according to claim 1, comprising:
generating a multiple user interaction streaming including the streamer and another streamer; wherein
the streamer is located in a first frame and the another streamer is located in a second frame; and
the edited first portion is overlapped on the first frame and on the second frame.

6. The server according to claim 1, comprising:
detecting a position of a first object; and
changing the position of the first object in response to the edited first portion being overlapped with the first object.

7. The server according to claim 1, wherein:
the triggering point is corresponding to a gift item sent by a viewer in response to receiving a signal from the viewer terminal indicating use of the gift item by the viewer; and
the gift item is a general gift item or gift item for a multiple user interaction, an event the streamer is participating in or a game the streamer is playing.

8. The server according to claim 1, wherein:
the edited first portion is processed from a pre-setting database, an image editing software or an AI machine learning model; and
the streamer is a real person, a virtual avatar with the real person or the virtual avatar with the AI machine learning model.

9. A method, comprising:
detecting a first triggering point in a live streaming room;
extracting a first portion of a streamer from a streaming data provided by the streamer in response to the first triggering point in the live streaming room being detected;
performing processing of image editing with respect to the first portion; and
rendering the edited first portion on the streaming data.

10. The method according to claim 9, comprising:
receiving a request from a first user of a first user terminal to use a virtual gift item associated with a first point;
generating a second point based on the first point, wherein the generated second point is higher than, equal to, or lower than the first point;
displaying the generated second point to a second user of a second user terminal in the live streaming room; and
updating points of the first user and the second user based on the first point and the generated second point; wherein
a mission associated with the live streaming room is triggered in response to the generated second point being lower than a threshold point.

11. The method according to claim 9, comprising:
retrieving event data associated with an event in which a first user of a first user terminal is participating in;
determining an emotional state and/or an appearance transformation corresponding to a progress state of the event;
generating a prompt command based on the emotional state and/or the appearance transformation;
transmitting the prompt command to an AI carrier associated with the first user of the first user terminal; and
updating the emotional state and/or the appearance transformation on the AI carrier according to the prompt command.

12. A non-transitory computer-readable medium including program instructions, that when executed by one or more processors, cause the one or more processors to execute:
detecting a first triggering point in a live streaming room;
extracting a first portion of a streamer from a streaming data provided by the streamer in response to the first triggering point in the live streaming room being detected;
performing processing of image editing with respect to the first portion; and
rendering the edited first portion on the streaming data.
